(19) United States
(12) Patent Application Publication
(10) Pub. No.: US 2018/0105430 A1
(43) Pub. Date: Apr. 19, 2018

(54) GENERATION OF MESOPOROUS MATERIALS USING MULTIPHASE SURFACTANT SYSTEMS

(71) Applicants: STC.UNM, Albuquerque, NM (US); SANDIA CORPORATION, Albuquerque, NM (US)

(72) Inventors: Eric C. Carnes, Albuquerque, NM (US); C. jeffrey Brinker, Albuquerque, NM (US); Darren Dunphy, Albuquerque, NM (US); Trevin Heisey, Albuquerque, NM (US)

(21) Appl. No.: 15/557,368

(22) PCT Filed: Mar. 11, 2016
(86) PCT No.: PCT/US2016/022056

§ 371 Date: Sep. 11, 2017

Related U.S. Application Data
(60) Provisional application No. 62/131,400, filed on Mar. 11, 2015.

(51) Int. Cl. C01B 33/18

(52) U.S. Cl. CPC C01B 33/18; B82Y 40/00; C01P 2006/17; C01P 2006/14

(57) ABSTRACT

The present invention relates to the discovery that mesoporous silica nanoparticles may be modified in pore size from the natural mesophase by generating mesoporous materials in binary, ternary or multiphase surfactant systems to produce biphasic, triphasic or multiphase mesoporous structures. Thus, the present invention relates to methods of producing biphase, triphasic and multiphase mesoporous structures with finely tuned mesopore size and protocells which are produced therefrom and mesoporous silica nanoparticles obtained therefrom. The resulting mesoporous nanostructures may be used to create protocells having unique cargo loading and release characteristics. Related protocells, pharmaceutical compositions and therapeutic and diagnostic methods are also provided.

This application claims the benefit of priority of U.S. provisional application No. 62/131,400 of identical title, filed Mar. 11, 2015, entire contents of which are incorporated by reference herein.

This invention was made with government support under DE-AC04-94AL85000 awarded by the Department of Energy. The government has certain rights in the invention.

### FIELD OF THE INVENTION

The present invention relates to the discovery that mesoporous silica nanoparticles may be modified in pore size from the natural mesophase by generating mesoporous materials in binary, ternary or multiphase surfactant systems to produce biphasic, triphasic or multiphase mesoporous structures. Thus, the present invention relates to methods of producing biphase, triphasic and multiphase mesoporous structures with finely tuned mesopore size and protocells which are produced therefrom. The resulting mesoporous nanostructures may be used to create protocells having unique cargo loading and release characteristics.

Related protocells, pharmaceutical compositions and therapeutic and diagnostic methods are also provided.

### BACKGROUND OF THE INVENTION

Nanoparticle (NP)/cell interactions, particularly in complex in vivo microenvironments, are regulated by an intricate spatiotemporal interplay of numerous biological and NP characteristics. Multiple NP physicochemical properties including, at the most basic level, material composition, size, shape, surface charge, and surface chemistry, have all been reported to play significant roles.¹⁻³ However, the relative importance of these diverse NP physicochemical properties in regulating interactions with various biological systems remains incompletely understood.¹ As such, achieving or avoiding cell-type specific interactions in vivo requires an improved understanding of the relative roles of these diverse NP properties, as well an ability to exert a high level of control over these properties during NP synthesis.

Generation of mesopores is usually accomplished by utilizing self-assembly of individual surfactants or block co-polymers. To modify the pore size from the natural mesophase, swelling agents such as tri-methyl benzene (TMB) are commonly employed. However, performance of swelling agents is often not reproducible, especially in the case of evaporation-driven assembly of thin-films and particles.

Thus, the need exists for nanoparticles and related syntheses which reflect simple and effective control over pore size and morphology. Further, an ability to simultaneously load NP's with a variety of diagnostic and/or therapeutic agents and to more effectively exploit NP shape and pore size would facilitate the identification and treatment of a numerous disorders, including cancers and bacterial and viral infections.

### SUMMARY OF THE INVENTION

To allow simple control over pore-size and morphology, the inventors have generated mesoporous materials utilizing binary surfactant systems, where single phase mixtures can be used to finely tune mesopore size, while two-phase separation of the surfactants can be used to generate biphasic mesoporous structures.

In one embodiment, the invention provides mesoporous silica nanoparticles (MSNPs) having a multiphase pore-surface structure and a multi-modal pore size distribution. In certain embodiments, the MSNPs have at least two distinct pore sizes ranging from about (1) (i) 0.001 to about 2 nm, or from about 0.01 to about 2 nm, preferably from about 0.03 nm to about 2 nm and/or (ii) from greater than about 50 nm to about 100 nm, and (2) from greater than about 2 nm to about 50 nm (i.e. the MSNP can include pore sizes in the mesoporous, microporous and macroporous ranges, as defined hereinafter).

In another embodiment, the invention provides a mesoporous silica nanoparticle (MSNP) that has a pore size of between about 0.03 nm to about 50 nm and a differential pore volume of between about 1 cm³/g to about 10 cm³/g, the MSNP being made by a process comprising forming a precursor mixture comprising a silicon precursor and a templating surfactant system comprised of at least one charged surfactant which may be a cationic or anionic surfactant, preferably a cationic surfactant and at least one poloxamer surfactant; drying the precursor mixture to form a surfactant-based self-assembled template and a silica precursor-based mesostructure phase that is ordered by the template; and thermally treating (e.g. calcination) the precursor to form the MSNP. The templating surfactant system which utilizes two or more surfactants which form immiscible phases upon mixing are preferred for use in the present invention. This templating system, based upon immiscible surfactants, when combined with the silicon precursor and heated, will produce multimodal MSNPs with phases having distinct pore sizes consistent (by way of pore size and distribution) with the surfactants included in each phase. The term “templating surfactant system” is used to describe a surfactant system comprising at least one charged surfactant and at least one poloxamer which are immiscible and which can be used to create at least two phases of silicon precursor materials which, after processing, result in bimodal and/or multimodal MSNPs as otherwise described herein.

In certain embodiments, the MSNPs are self-assembled using a templating surfactant system comprised of at least one anionic or cationic surfactant and at least one poloxamer, wherein the surfactants are immiscible (form immiscible phases at varying weight ratios). In certain embodiments, these MSNPs have a pore size of between about 2 nm to about 50 nm and a differential pore volume of between about 1 cm³/g to about 10 cm³/g. In other embodiments, the MSNPs have a multi-modal pore size distribution of between about 0.03 nm to about 2 nm and from about 3 nm to about 50 nm.

Preferably, the charged surfactant and poloxamers, even more preferably cationic surfactant and poloxamers used in the aforementioned surfactant system have or form different phases and the resulting MSNPs have a biphasic pore-surface structure. In some embodiments, the templating surfactant system is comprised of three or more surfactant components each, including at least one cationic surfactant and at least one poloxamer, and at least three of the surfactant components have different phases (are immiscible with each other), resulting in “multimodal” MSNPs with at least three different pore sizes. The term “bimodal” is used to describe MSNP's with two different pores sizes.

Exemplary anionic surfactants include a dodecylsulfate salt (most preferably sodium dodecylsulfate or lithium dodecylsulfate (SDS)), and exemplary cationic surfactants include a tetradecyl-trimethyl-ammonium salt (most preferably tetradecyl-trimethyl-ammonium bromide (C₁₄TAB) or tetradecyl-trimethyl-ammonium chloride), a hexadecyltrimethylammonium salt (mostly preferably hexadecyltrimethylammonium bromide (C₁₆; CTAB)), an octadecyltrimethylammonium salt (most preferably octadecyltrimethylammonium bromide (C₁₈; OTAB)), a dodecylethyldimethylammonium salt (most preferably dodecylethyldimethylammonium bromide), a cetylpyridinium salt (most preferably cetylpyridinium chloride (CPC)), polyethoxylated tallow amine (POEA), hexadecyltrimethylammonium p-toluenesulfonate, a benzalkonium salt (most preferably benzalkonium chloride (BAC)), or a benzethonium salt (most preferably benzethonium chloride (BZT)) and mixtures thereof. In certain embodiments according to the invention, the use of cationic surfactants may be preferred.

In one particularly preferred embodiment, the MSNPs have at least two distinct pore sizes ranging from about 0.03 nm to about 2 nm and from about 3 nm to about 10 nm; the poloxamer is P123 or F127; and the cationic surfactant is hexadecyltrimethylammonium bromide (C₁₆; CTAB).

In certain embodiments of the MSNPs described herein, the weight percentage ratio of charged surfactant (which can be an anionic or cationic surfactant, preferably a cationic surfactant) to poloxamer varies from about 1:99, or from about 2:98, or from about 3:97, or from about 4:96, or from about 5:95, or from about 6:94, or from about 7:93, or from about 8:92, or from about 9:91, or from about 10:90, or from about 15:85, or from about 20:80, or from about 25:75, or from about 30:70, or from about 35:65, or from about 40:60, or from about 41:59, or from about 42:58, or from about 43:57, or from about 44:56 or from about 45:55, or from about 46:54, or from about 47:53, or from about 48:52, or from about 49:51 or from about 50:50, or from about 51:49, or from about 52:48, or from about 53:47, or from about 54:46, or from about 55:45, or from about 56:44, or from about 57:43, or from about 58:42, or from about 59:41, or from about 60:40, or from about 65:35, or from about 70:30, or from about 75:25, or from about 80:20, or from about 85:15, or from about 90:10, or from about 91:9, or from about 92:8, or from about 93:7, or from about 94:6, or from about 95:5, or from about 96:4, or from about 97:3, or from about 98:2, or from about 99:1.

Notably, MSNPs of the invention can be loaded simultaneously or after formation with a small molecule active agent, a siRNA, a mRNA and a plasmid. For example, the MSNPs' may be loaded with at least one macromolecule selected from the group consisting of a nucleic acid, small molecule active agent, polypeptide/protein or a carbohydrate. Examples of such cargo include polynucleotides such as RNA, including mRNA, siRNA, shRNA micro RNA, a protein, including a therapeutic protein and/or a protein toxin (e.g. ricin toxin A-chain or diphtheria toxin A-chain) and/or DNA (including double stranded or linear DNA, minicircle DNA, plasmid DNA which may be supercoiled and/or packaged (e.g. with histones) and which may be optionally modified with a nuclear localization sequence). The DNA may be capable of expressing any number of polypeptides. In some embodiments, simultaneous loading of a small molecule active agent, a siRNA, shRNA, mRNA, microRNA, minicircle DNA and a plasmid is achieved by loading each of the distinct cargo components in differently sized pores of “triphasic (+)” MSNPs. In other embodiments, one or more cargo components is loaded either exclusively onto the MSNP surface or is loaded through pore and/or surface loading.

In certain embodiments, the surface of the MSNPs includes or is complexed with: (a) a nucleic acid that encodes a siRNA (preferably a siRNA that suppresses gene expression in human tumor cells) operatively linked with a promoter; and (b) a cancer cell targeting ligand. The nucleic acid can be dsDNA and the cancer cell targeting ligand can be a tumor-targeting human monoclonal antibody or a single-chain variable fragment (scFv) thereof. The MSNPs can also be complexed with one or more additional anti-cancer agents.

In other embodiments, the MSNPs are loaded or complexed with:

a cell targeting species (e.g. a targeting peptide such as a SP94 peptide or a MET binding peptide or other cell targeting peptide) and at least one cargo component selected from the group consisting of a polynucleotide, e.g., double stranded linear DNA, minicircle DNA, plasmid DNA (which (1) can be optionally modified to express a nuclear localization sequence (2) can be supercoiled and/or packaged plasmid DNA (3) can be histone-packaged supercoiled plasmid DNA comprising a mixture of human histone proteins (4) may be capable of expressing a polypeptide which may be therapeutic and/or toxic (e.g. ricin toxin chain-A or diphtheria toxin chain-A)), a messenger RNA, a small hairpin RNA (shRNA), a small interfering RNA (siRNA)) or microRNA, a drug, an imaging agent (e.g. green fluorescent protein or red fluorescent protein) or a mixture thereof, and wherein one of said cargo components is optionally conjugated further with a nuclear localization sequence. In some embodiments, the shRNA and siRNA induce cell apoptosis or inhibit the synthesis of endogenous proteins/polypeptides.

The invention also includes protocells in which the novel MSNPs described herein are encapsulated within a lipid bi- or multilayer, and pharmaceutical compositions comprising MSNPs and protocells. Methods of treating a variety of disorders, including a cancer and bacterial and viral infections are also provided.

In addition to facilitating syntheses of bi- and multiphasic MSNPs through techniques such as evaporation-induced self-assembly (EISA), the present invention significantly enhances MSNP cargo capacity, improves controlled delivery of compositions such as dsDNA plasmids and other cargo to a variety of cells in vitro and in vivo and enables pore size control that extends MSNP utility to applications such as in vivo detoxification and patient-specific drug delivery.

The ability pursuant to the present invention to vary size, charge, charge exposure and PEGylation of the nanoparticles and protocells described herein can be controlled to such an extent that specifically tuned particles can be controllably deposited within certain tissue types (e.g. to a tumor, immune cells etc.). By modifying MSNP core (size, shape, mass) and surface properties, we can alter in vivo biodistribution by changing the proportion of particles arrested in different types of cells and tissues. This control over the particles allows for precise physiochemical targeting of specific cell and tissue types.

In certain preferred embodiments, the MSNPs of the present invention, are particularly useful for the delivery of larger nucleic acids (from 100 nucleotide bases to more than 1000 kb, about 1 kb-1,000 kb, about 2 kb to about 750 kb, about 5 kb to about 500 kb, about 10 kb to about 250 kb, about 25 kb to about 200 kb) (e.g. double stranded DNA, plasmid DNA, including CRISPR plasmids, mini-circle DNA, naked DNA, and messenger RNA), as well as for larger polypeptides or proteins (from 25 amino acids to more than 5000 aa, about 50 aa-1000 aa, about 75 aa to about 750 aa, about 100 aa 500 a, about 35 aa to about 250 aa, about 30 aa to about 200 aa). In addition, these MSNPs of the present invention may also be used to deliver larger nucleic acids from one phase with larger pore diameters and additional cargo, especially including small molecules, from one or more additional phases with smaller pore diameters.

In another embodiment, the invention provides a method of preparing the MSNPs pursuant to the present invention which involves forming a precursor mixture comprising a silica precursor and a templating surfactant system comprised of at least one charged surfactant (anionic or cationic), preferably a cationic surfactant and at least one poloxamer; drying the precursor mixture to form a surfactant-based self-assembled template and a silica precursor-based mesostructure phase that is ordered by the template; and thermally treating the precursor to form ordered MSNPs. Thus, aerosol-assisted evaporation-induced self-assembly methods such as those described in U.S. Patent Application Document No. 20140079774 (the complete contents of which are hereby incorporated by reference) can be varied by the use of bi- or multiphase templating surfactant systems comprised of at least one charged, preferably cationic surfactant and at least one poloxamer as described herein.

“A precursor mixture comprising a silica precursor and a templating surfactant system comprised of at least one charged surfactant of the same charge (anionic or cationic), preferably at least one cationic surfactant and at least one poloxamer” which can be a multiphase emulsion comprising a precursor solution dispersed within an oil phase, wherein: (a) the precursor solution comprises (1) tetraethyl orthosilicate (TEOS), tetramethyl orthosilicate (TMOS) or a mixture thereof, and (2) at least one cationic or anionic surfactant (preferably at least one cationic surfactant) and at least one poloxamer; and wherein (b) the oil phase comprises a C₁₂-C₃₆ alkane, preferably a C₁₂-C₂₀ alkane and at least one non-ionic emulsifier soluble in the oil phase.

Certain embodiments provide alternative processes for making a population of monodisperse, colloidally-stable MSNPs which are optionally PEGylated and/or modified with SiOH/PEG and which are optionally aminated using aminated silanes as described herein. It is noted that when additional components are added to the surfactant and silica precursor form the mesoporous materials as otherwise described herein, care must be taken to limit the additional components so as not to impact the separate phases which are produced during synthesis and give rise to the bimodal/multimodal mesoporous materials (MSNPs) of the present invention.

Thus, MSNPs of the invention represent a simple and cost-effective approach to creating particles (nano to micro) with discrete layers consisting of pores of differing sizes and connectivities, thus providing unique opportunities for delivering cargo in therapeutic and/or diagnostic applications. More specifically, CTAB templated pores feature small diameters (<3 nm), which are ideal for loading smaller molecules. The surface area of CTAB-only particles which is approximately 1,000 m²/g, would yield a high percentage loading of small molecule cargo. In contrast, F127 templating yields larger pores (3-10 nm) suitable for loading larger macromolecules (siRNA, etc.). However, as the pore diameter increases, surface area necessarily decreases (to approximately 300 m²/g in the case of the 10 nm pores), lowering the overall percentage of cargo that can be loaded into these particles (loading scales linearly with surface area). Other charged surfactants and poloxamers may be used to modify the pore sizes with the same effects being realized.

Since F127 and CTAB phase-separate at all concentrations, this combination can be used to template particles that self-assemble into structures with multi-modal pores. As described hereinafter, we demonstrate this over a range of percentages of CTAB:F127, showing the ability to control the various ratios of large to small pores and their relative domains/locations on the particles. Gas adsorption verified multimodal distribution evident from TEM. Although TEM suggests that pores of different diameters exist in discrete layers at fixed distances from the particle surface, gas adsorption suggests that this is not necessarily the case—such that large molecules could diffuse directly into large pores without having to traverse smaller pores and potentially be rejected. This surface accessibility can be controlled by varying the ratio of the two surfactants.

Significantly, this phenomenon is not limited to F127 and CTAB, and can be extended to any surfactant combination that does not form mixed phases (i.e., the phases are immiscible), preferably at all concentrations of the mixture for ease of application. More than two templating surfactants that can all coexist as discrete phases can be used to create even more layers of pores with different sizes/connectivities, depending upon the size or length of the surfactant, its shape, charge and hydrophobicity, all characteristics which will influence the eventual pore size in the phase. This ability to fine tune diffusion rates of individual molecules into/out of the particles makes the MSNPs of the invention particularly useful as molecular sieves and as therapeutics capable of removing toxins/heavy metals from the human body. Further, the MSNPs of the invention exhibit controlling release rates of complex therapeutic cargo mixtures from within the particle, thereby serving as next-generation drug delivery systems.

In another embodiment, the present invention is directed to a method of preparing a mesoporous silica nanoparticle (MSNP) that has a pore size of between about 0.03 nm to about 50 nm and a differential pore volume of between about 1 cm³/g to about 10 cm³/g, the method comprising forming a precursor mixture comprising a silica precursor and a templating surfactant system comprised of at least one charged surfactant which is anionic or cationic, preferably at least one cationic surfactant and at least one poloxamer; drying the precursor mixture to form a surfactant-based self-assembled template and a silica precursor-based mesostructure phase that is ordered by the template; and thermally treating the precursor to form the MSNP, the resulting MSNP containing two or more distinct phases having different pore sizes which reflect the surfactant which is contained in each phase.

In another embodiment, the invention is directed to a multiphase emulsion which comprises a precursor solution dispersed within an oil phase, wherein:

(a) the precursor solution comprises (1) tetraethyl orthosilicate (TEOS), tetramethyl orthosilicate (TMOS) or a mixture thereof, and (2) at least one charged (anionic or cationic, preferably cationic) surfactant and at least one poloxamer; and wherein
(b) the oil phase comprises a C₁₂-C₃₆, preferably a C₁₂-C₂₀ alkane and a non-ionic emulsifier soluble in the oil phase.

In a preferred method for making bimodal/multimodal mesoporous materials according to the present invention, an aqueous silica precursor comprising tetraethylorthosilicate (TEOS) and/or tetramethylorthosilicate (TMOS) are added to a single phase mixture of a volatile solvent (e.g. ethanol, methanol, isopropanol) that is miscible with water and water at an acidic pH (e.g., about 2). Surfactants (charged, preferably cationic and poloxamer at concentrations which are immiscible after evaporation of the volatile solvent) are added directly to the mixture and sonicated to dissolve the surfactants to provide a single phase. The volatile solvents are evaporated (e.g., using nitrogen aerosolization with controlled volumes and temperature gradients to control the evaporation of the solvent) to promote self-assembly and multi-phase particles formation. After evaporation of all solvent, the particles are collected on a membrane filter and surfactant is extracted (e.g. using calcination or solvent/acid liquid extraction. This approach may be used for ternary, quaternary and anionic, etc. surfactant mixtures. In certain embodiments, CTAB is added to a mixture of F127 and P123 that phase separate, resulting in particles which display 3 distinct pore structures with varying pore diameters. Porosity is often a function of the surfactant concentration, whereas pore size (diameter) is a function of the size (length) of the surfactant molecule used.

In an alternative embodiment, multimodal silica particles may be made using an emulsion process. In this method, at least one charged surfactant and poloxamer surfactant (which are immiscible in each other) are dissolved in water and then TEOS and/or TMOS are added to the surfactant solution and thoroughly mixed. An oil phase comprised of one or more alkane is prepared and an emulsifier solution in the oil phase is prepared and the precursor sol containing the surfactants and TEOS and/or TMOS is combined with the oil phase and stirred vigorously to produce a water-in-oil emulsion. This emulsion is then evaporated to remove the solvent, producing particles therefrom which are centrifuged (e.g. at a sufficient speed), decanted to remove supernatant, followed by heating (e.g. calcination) to remove surfactants and excess organic matter to provide multimodal MSNPs.

In another embodiment, bimodal/multimodal MSNPs according to the present invention a solution is formed from water, a volatile solvent miscible in water (e.g., methanol, ethanol, isopropanol, etc.), a surfactant mixture containing at least two surfactants which are immiscible in each other and an acid solution are mixed to homogeneity and TEOS and/or TMOS are added to the surfactant mixture to form a silica/surfactant mixture or sol. The sol is then aerosolized under elevated temperature to produce droplets of the mixture which are subsequently evaporated to produce nanoparticles, which are subsequently captured on a capture membrane (e.g., polyethersulfone or other material). When the sol has been completely aerosolized and no liquid remains, the particles are collected to remove surfactant. Surfactant is removed at elevated temperature are recollected to produce bimodal and/or multimodal MSNPs.

Once produced, the MSNPs according to the present invention may be used directly or coated with a phospholipid bilayer as otherwise described herein.

These and other aspects of the invention are described further in the Detailed Description of the Invention.

### BRIEF DESCRIPTION OF THE FIGURES

FIGS. 1-5 show porosity as a function of varying surfactant concentration in an EISA binary surfactant system.

FIG. 1 shows mesoporous silica nanoparticles which were generated using the evaporation-induced self-assembly process (EISA), using a binary set of surfactants featuring an ionic polymer, hexadecyltrimethylammonium bromide (CTAB or C₁₆TAB), and a non-ionic block copolymer, Pluronic® F-127. Shown is X-ray diffraction (XRD) data for various mesoporous silica particles formed in this manner using various mass percentages of CTAB to F-127, where we see a gradual transition from a disordered/cubic packing structure when particles are made with no CTAB present (100% F127) to the well-known hexagonal packing structure formed by CTAB micelles at higher CTAB concentrations (100% CTAB). Corresponding TEM micrographs provide visual confirmation of the structures indicated by the XRD data.

FIG. 2 shows data identical to that as in FIG. 1, with XRD data plots separated for visual clarity and presented with corresponding TEM micrographs.

FIG. 3 shows TEM micrographs of mesoporous silica nanoparticles made using EISA particles and binary surfactant system (CTAB and F127). At these higher concentrations of CTAB, it is visually evident that increasing CTAB concentration results in longer-range formation of CTAB-templated 2-nm mesopores at the particles surface, while F-127-templated larger pores remain at center of particles.

FIG. 4 shows TEM micrographs of mesoporous silica nanoparticles made using EISA particles and binary surfactant system (CTAB and F127). At these moderate concentrations of CTAB, it is visually evident that increasing CTAB concentration results in longer-range formation of CTAB-templated 2-nm mesopores at the particles surface, while F-127-templated larger pores remain at center of particles, further demonstrating control over particle porosity development. Images at approximately equal mass of CTAB:F-127 (50% CTAB) seem to indicate the potential for a mixed phase of porosity being present in the particles. This is not, however, indicated by XRD data.

FIG. 5 shows TEM micrographs of mesoporous silica nanoparticles made using EISA particles and binary surfactant system (CTAB and F127). At these low concentrations of CTAB, we begin to see the evolution of a layer of small CTAB-templated pores at the surface of the particles, while F-127-templated larger pores remain at center of particles. Increasing CTAB concentrations appear to increase the thickness of this outer layer of small pores, without effecting large-pore porosity in center of particle resulting from F-127 templating.

FIG. 6 shows binary surfactant system XRD data at different weight percentage ratios of cationic surfactant:poloxamer. The data generated in FIG. 6 is pursuant to the description in the figure legend.

FIG. 7 shows nitrogen porosimetry data on mesoporous silica nanoparticles obtained using EISA method and a binary surfactant system comprised of CTAB and F-127, with quantity of nitrogen absorbed over varying partial pressure (top) and corresponding transformation to determine pore volume and width of those particles using Brunauer-Emmett-Teller (BET) theory. Particles made from 100% CTAB show the commonly reported 2.4 nm pore diameter, as well as the lack of hysteresis during adsorption and desorption at any partial pressure. For figures below at decreasing amounts of CTAB (increasing amounts of F-127), we see an increasing level of hysteresis during adsorption and desorption corresponding to reported-mesophases formed by F-127, along with the presence of pores of approximately 8-12 nm (see FIG. 26), commonly found in materials template with F-127. This data also suggests the possibility of F-127 templated pores of smaller diameter (4-6 nm) augmented by the presence of CTAB in the micelles. However, evidence of this mixed phase is not seen in corresponding XRD data (FIGS. 1, 2, and 6).

FIGS. 8-26 show the effect of varying the weight percentage ratio of cationic surfactant:poloxamer on (a) adsorption and desorption and (b) pore size and differential pore volume. The data presented in FIGS. 8-26 were generated pursuant to the description in the legend of FIG. 7.

### DETAILED DESCRIPTION OF THE INVENTION

The following terms shall be used throughout the specification to describe the present invention. Where a term is not specifically defined herein, that term shall be understood to be used in a manner consistent with its use by those of ordinary skill in the art.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either both of those included limits are also included in the invention. In instances where a substituent is a possibility in one or more Markush groups, it is understood that only those substituents which form stable bonds are to be used.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described.

It must be noted that as used herein and in the appended claims, the singular forms “a,” “and” and “the” include plural references unless the context clearly dictates otherwise.

Furthermore, the following terms shall have the definitions set out below.

Conventionally, a “mesoporous” nanoparticle has pores whose diameters range in size from about 2 nm to about 50 nm, a “microporous” nanoparticle has pores whose diameters are less than about 2 nm (often about 0.001 to about 2 nm) and a “macroporous” nanoparticle has pores whose diameters are from about 50 nm to about 100 nm. MSNPs of the invention can have both mesoporous, microporous and macroporous pores, but most often have pores whose diameters range in size from about 2 nm to about 50 nm.

The term “poloxamer” is used to describe nonionic triblock copolymers which are used in the present invention. Poloxamers comprise a central hydrophobic chain of polyoxypropylene or poly(propylene oxide) bound at the distal ends of the central chain by two hydrophilic chains of poly(ethylene oxide). Poloxamers are also known by their trade names Synperonics®, Pluronics® and Kolliphore®. Poloxamers are represented by the chemical formula:

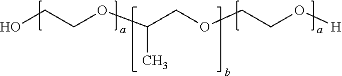

The lengths of the polymer blocks can be customized. Accordingly, a large number of different poloxamers exist that have slightly different properties and can be tuned to provide phases with different numbers of pores (as a function of surfactant concentration) and pore sizes (as a function of surfactant length or size) as is generally discussed herein. Generic poloxamer copolymers are commonly named with the letter “P” (for poloxamer) followed by three digits: the first two digits×100 give the approximate molecular mass of the polyoxypropylene core, and the last digit×10 gives the percentage polyoxyethylene content. Thus poloxamer P407 (synonymous with Pluronic F-127) is a poloxamer with a polyoxypropylene molecular mass of about 4,000 g/mol and a 70% polyoxyethylene content. For the Pluronic® and Synperonic® tradenames, coding of these copolymers starts with a letter to define its physical form at room temperature (L=liquid, P=paste, F=flake (solid)) followed by two or three digits, The first digit (two digits in a three-digit number) in the numerical designation, multiplied by 300, indicates the approximate molecular weight of the hydrophobe; and the last digit×10 gives the percentage polyoxyethylene content. Thus, L61 indicates a polyoxypropylene molecular mass of about 1,800 g/mol and a 10% polyoxyethylene content. Thusly, poloxamer 181 (P181) is the same as Pluronic L61 and Synperonic PE/L 61.

The poloxamers may be modified to produce a larger number of nonionic surfactants useful in the present invention. Thus, the poloxamers may be modified to produce surfactants which are immiscible with cationic and/or anionic surfactants which are otherwise useful in the present invention. In addition, the poloxamers may be modified to provide shorter chain surfactants and/or longer chain surfactants to influence the size of the pores which are created in those phases in which the poloxamer is found. Poloxamers which may be used in the present invention include any poloxamer which is immiscible with a charged surfactant, preferably with a cationic surfactant as otherwise described herein. Poloxamers may vary widely in content preferably ranging from about 1% to about 99% by weight poly(oxypropylene) to about 99% to about 1% by weight poly(ethylene oxide), about 2.5% to about 97.5% by weight poly(oxypropylene) to about 97.5% to about 2.5% by weight poly(ethylene oxide), often about 5% to about 95% poly(oxypropylene) to about 95% to about 5% poly(ethylene oxide), often about 10% to about 90% poly(oxypropylene) to about 90% to about 10% poly(ethylene oxide) and about 30% to about 70% by weight poly(oxypropylene) to about 70% to about 30% by weight poly(ethyleneoxide). Preferred poloxamers comprise a poly(oxypropylene) chain having a molecular mass ranging from about 500 g/mol to about 15,000 g/mol, about 1000 g/mol to about 12,000 g/mol, often about 1500 g/mol to about 10,000 g/mol, often about 1750 g/mol to about 8,000 g/mol, often about 2000 g/mol to about 7000 g/mol, often about 2500 g/mol to about 6000 g/ml, about 3000 g/ml to about 5000 g/mol. Preferred poloxamers comprise two poly(ethylene oxide) chains at each end of the poly(oxypropylene) chain each having a molecular mass ranging from about 90-100 g/mol to about 10,000 g/mol, often about 500 g/mol to about 7,500 g/mol, about 750 to about 5,000 g/mol, about 1,000 g/mol to about 3,500 g/mol, about 1500 to about 3000 g/ml.

“Multiphase pore-surface structure” means that a nanoparticulate's pores and surface exhibit two (biphasic) or more (triphasic, tetraphasic, etc.) distinct morphologies (e.g. crystalline or amorphous structures), as determined through well-known techniques such as X-ray absorption spectroscopy (XAS), X-ray diffraction (XRD) and inductively coupled plasma (ICP). See e.g. Moreau, et al., “Defining Crystalline/Amorphous Phases of Nanoparticles through X-ray Absorption Spectroscopy and X-ray Diffraction: The Case of Nickel Phosphide”, Chem. Mater., 2013, 25 (12), pp 2394-2403.

“Charged surfactant and the poloxamer have different phases” means that the charged surfactant (in particular, one or more anionic or cationic surfactants), preferably a cationic surfactant and the poloxamer exhibit apparent absolute immiscibility, at certain weight ratios, but preferably at all ratios of the charged surfactant (anionic or cationic surfactant) and the poloxamer. To take advantage of multiple-surfactant systems in order to yield particles with multiple pore diameters/structures pursuant to the present invention, it is an essential feature to exploit the immiscibility of the surfactants within the surfactant system. The immiscibility of the surfactants may be readily determined. In order to form multiple discrete mesophases, surfactants are chosen to be immiscible at the desired mass percentage(s) of the mesophase, thus producing distinct phases in the precursor material which is used to create the final mesoporous materials. Desired mass percentage is determined from the relative amounts of each mesophase desired in a resulting particle and also can be thought of as the desired thickness of “shell” comprised of different pore diameter structure than the core of the particle. Surfactant combinations can be readily determined by the skilled person. For example, if a “thin” shell of ˜2.4 nm pores is desired around a core of 8-10 nm pores, this “biphasic” mesoporous material is prepared by selecting a binary surfactant system that would be immiscible at low concentrations of the surfactant desired to form the smaller pores (for instance, CTAB or other smaller/shorter-lengthed surfactant) within higher concentrations of the surfactant desired to form the larger pores (for instance, F-127 or other larger/longer-lengthed surfactants). For a “shell” of larger thickness, one must ensure that the surfactant system is immiscible at high concentrations of the smaller-micelle surfactant to the large-micelle surfactant. In general, the length of the surfactant, along with its shape, charge and hydrophobicity controls the size of the micelle which is formed from the surfactant molecules. By choosing an appropriate combination of surfactants which are immiscible and which have different characteristics as described above to provide different micelle sizes, the person of skill may provide surfactant combinations which produce two or more phases of varying thicknesses which also provide different pore sizes. The characteristics which can be “dialed in” to the mesoporous materials may provide substantial influence over the type and amount of cargo which can be loaded into mesoporous materials according to the present invention and the release of cargo from the loaded mesoporous materials after administration to a patient or subject.

By way of particular example, as the CTAB/F-127 (cationic surfactant/poloxamer) system appears to be immiscible at all concentrations, it would be suitable for use in both examples described here for thick and thin “shells.” This is also true for other surfactant combinations where the individual surfactants are immiscible in each other. However, when binary surfactant systems are chosen with ample solubility at the given mass ratios, only one pore structure/diameter will be formed (for example, 50 wt % F-127 and Pluronics P123).” Thus, pursuant to the present invention, a variety of bi- and triphasic mesoporous materials may be produced. It is also noted herein that the amount of a particular surfactant compared to the alternative surfactant(s) in surfactant systems which are used to create bimodal/multimodal MSNPs pursuant to the present invention, will control the size of the phase produced in the final biphasic/multiphasic MSNP produced.

“Self-assembly using a templating surfactant system”, e.g. as employed in aerosol-assisted evaporation-induced self-assembly (EISA), is described in Lu, Y. F. and Brinker J. C. et al. Aerosol-assisted self-assembly of mesostructured spherical nanoparticles”, Nature 398, 223-226 (1999)), the complete contents of which are hereby incorporated by reference. Example 1 herein illustrates an EISA process. As explained in U.S. Pat. No. 8,334,014, “[t]emplating of oxide materials with surfactant micelles is a powerful method to obtain mesoporous oxide structures with controlled morphology. In this method, an oxide precursor solution is mixed with a templating surfactant and evaporation of the solvent leads to an increase in the surfactant concentration. The surfactant forms supra-molecular structures according to the solution phase diagram. This is known as evaporative induced self-assembly (EISA) and has been used to obtain bulk porous materials or microparticles using high-temperature aerosol methods. Alternatively, mesoporous particle synthesis via EISA can be performed in water in oil emulsion droplets under milder temperature stresses (citations omitted).”

A “multi-modal pore size distribution” means that there are two or more nanoparticle pore size distributions within a single nanoparticle, as opposed to a monomodal pore size distribution which exhibits a Gaussian or log normal form.

“Differential pore volume distributions” can be considered in the broadest sense to be logarithmic differential pore volume distributions defined by plots of (dV/dlog(D) vs. D (or [dV/dr]/[d(log (r)/dr] vs. r, where V is nanoparticle volume, D is nanoparticle diameter and r is nanoparticle radius. Differential pore volume distributions may be determined in a number of ways, including through use of the Barret-Joyner-Halenda (BJH) model, the Horvath-Kawazoe (HK) model and the Density Functional Theory (DFT) model, as illustrated in Muhammad Afiq Aizuddin Musa, Chun-Yang Yin and Robert Mikhail Savory, 2011, Analysis of the Textural Characteristics and Pore Size Distribution of a Commercial Zeolite using Various Adsorption Models, Journal of Applied Sciences, 11: 3650-3654. The theoretical bases of differential pore size distribution are presented in Meyer, et al., Comparison between different presentations of pore size distribution in porous materials, Fresenius' Journal of Analytical Chemistry, Vol. 363, Issue 2, pp. 174-178.

The term “patient” or “subject” is used throughout the specification within context to describe an animal, generally a mammal, especially including a domesticated animal and preferably a human, to whom treatment, including prophylactic treatment (prophylaxis), with the compounds or compositions according to the present invention is provided. For treatment of those infections, conditions or disease states which are specific for a specific animal such as a human patient, the term patient refers to that specific animal. In most instances, the patient or subject of the present invention is a human patient of either or both genders.

The term “effective” is used herein, unless otherwise indicated, to describe an amount of a compound or component which, when used within the context of its use, produces or effects an intended result, whether that result relates to the formation of multimodal mesoporous materials described herein or prophylaxis and/or therapy of an infection and/or disease state or as otherwise described herein. The term effective subsumes all other effective amount or effective concentration terms (including the term “therapeutically effective”) which are otherwise described or used in the present application.

The term “compound” is used herein to describe any specific compound or bioactive agent disclosed herein, including any and all stereoisomers (including diasteromers), individual optical isomers (enantiomers) or racemic mixtures, pharmaceutically acceptable salts and prodrug forms. The term compound herein refers to stable compounds. Within its use in context, the term compound may refer to a single compound or a mixture of compounds as otherwise described herein.

The term “cargo” is used herein to describe any molecule or compound, whether a small molecule or macromolecule having an activity relevant to its use in MSNPs, especially including biological activity, which can be included in MSNPs according to the present invention. The cargo may be included within the pores and/or on the surface of the MSNP according to the present invention. Representative cargo may include, for example, a small molecule bioactive agent, a nucleic acid (e.g. RNA or DNA), a polypeptide, including a protein or a carbohydrate. Particular examples of such cargo include RNA, such as mRNA, siRNA, shRNA micro RNA, a polypeptide or protein, including a protein toxin (e.g. ricin toxin A-chain or diphtheria toxin A-chain) and/or DNA (including double stranded or linear DNA, complementary DNA (cDNA), minicircle DNA, naked DNA and plasmid DNA (including CRISPR plasmids) which optionally may be supercoiled and/or packaged (e.g. with histones) and which may be optionally modified with a nuclear localization sequence). Cargo may also include a reporter as described herein.

A nanoparticle may have a variety of shapes and cross-sectional geometries that may depend, in part, upon the process used to produce the particles. In one embodiment, a nanoparticle may have a shape that is a torus (torroidal), which is the preferred embodiment of the present invention. A nanoparticle may include particles having two or more of the aforementioned shapes. In one embodiment, a cross-sectional geometry of the particle may be one or more of torroidal, circular, ellipsoidal, triangular, rectangular, or polygonal. In one embodiment, a nanoparticle may consist essentially of non-spherical particles. For example, such particles may have the form of ellipsoids, which may have all three principal axes of differing lengths, or may be oblate or prelate ellipsoids of revolution. Non-spherical nanoparticles alternatively may be laminar in form, wherein laminar refers to particles in which the maximum dimension along one axis is substantially less than the maximum dimension along each of the other two axes. Non-spherical nanoparticles may also have the shape of frusta of pyramids or cones, or of elongated rods. In one embodiment, the nanoparticles may be irregular in shape. In one embodiment, a plurality of nanoparticles may consist essentially of spherical nanoparticles.

The phrase “effective average particle size” as used herein to describe a multiparticulate (e.g., a porous nanoparticulate) means that at least 50% of the particles therein are of a specified size. Accordingly, “effective average particle size of less than about 2,000 nm in diameter” means that at least 50% of the particles therein are less than about 2,000 nm in diameter. In certain embodiments, nanoparticulates have an effective average particle size of less than about 2,000 nm (i.e., 2 microns), less than about 1,900 nm, less than about 1,800 nm, less than about 1,700 nm, less than about 1,600 nm, less than about 1,500 nm, less than about 1,400 nm, less than about 1,300 nm, less than about 1,200 nm, less than about 1,100 nm, less than about 1,000 nm, less than about 900 nm, less than about 800 nm, less than about 700 nm, less than about 600 nm, less than about 500 nm, less than about 400 nm, less than about 300 nm, less than about 250 nm, less than about 200 nm, less than about 150 nm, less than about 100 nm, less than about 75 nm, less than about 50 nm, less than 30 nm, less than 25 nm, less than 20 nm, less than 15 nm, less than 10 nm, as measured by light-scattering methods, microscopy, or other appropriate methods. “D₅₀” refers to the particle size below which 50% of the particles in a multiparticulate fall. Similarly, “D₉₀” is the particle size below which 90% of the particles in a multiparticulate fall.

The MSNP size distribution, according to the present invention, depends on the application, but is principally monodisperse (e.g., a uniform sized population varying no more than about 5-20% in diameter, as otherwise described herein). The term “monodisperse” is used as a standard definition established by the National Institute of Standards and Technology (NIST) (Particle Size Characterization, Special Publication 960-1, January 2001) to describe a distribution of particle size within a population of particles, in this case nanoparticles, which particle distribution may be considered monodisperse if at least 90% of the distribution lies within 5% of the median size. See Takeuchi, et al., Advanced Materials, 2005, 17, No. 8, 1067-1072.

In certain embodiments, mesoporous silica nanoparticles can be range, e.g., from around 5 nm to around 500 nm (preferably about 50 nm to about 500 nm) in size, including all integers and ranges there between. The size is measured as the longest axis of the particle. In various embodiments, the particles are from around 10 nm to around 500 nm and from around 10 nm to around 100 nm in size. The mesoporous silica nanoparticles have a porous structure. The pores can be from around 1 to around 20 nm in diameter, including all integers and ranges there between. In one embodiment, the pores are from around 1 to around 10 nm in diameter. In one embodiment, around 90% of the pores are from around 1 to around 20 nm in diameter. In another embodiment, around 95% of the pores are around 1 to around 20 nm in diameter.

Preferred MSNPs according to the present invention: are monodisperse and range in size from about 25 nm to about 300 nm; exhibit stability (colloidal stability); have single cell binding specification to the substantial exclusion of non-targeted cells; are neutral or cationic for specific targeting (preferably cationic); are optionally modified with agents such as PEI, NMe3+, dye, crosslinker, ligands (ligands provide neutral charge); and optionally and preferably, are used in combination with a cargo to be delivered to a targeted cell.

In certain embodiments, the MSNPs are monodisperse and range in size from about 25 nm to about 300 nm. The sizes used preferably include 50 nm (+/−10 nm) and 150 nm (+/−15 nm), within a narrow monodisperse range, but may be more narrow in range. A broad range of particles is not used because such a population is difficult to control and to target specifically.

Illustrative examples of a “cationic surfactant” include, but are not limited to, cetyl trimethylammonium bromide (CTAB), dodecylethyldimethylammonium bromide, cetylpyridinium chloride (CPC), polyethoxylated tallow amine (POEA), hexadecyltrimethylammonium p-toluenesulfonate, benzalkonium chloride (BAC), or benzethonium chloride (BZT).

The term “PEGylated” in its principal use refers to an MSNP which has been produced using PEG-containing silanes or zwitterionic group-containing silanes to form the MSNP. In general, the amount of the PEG-containing silanes and/or zwitterionic-containing silanes which optionally are used to produce MSNPs according to the present invention represent about 0.05% to about 50% (about 0.1% to about 35%, about 0.5% to about 25%, about 1% to about 20%, about 2.5% to about 30%, about 0.25% to about 10%, about 0.75% to about 15%) by weight of these monomers in combination with the silane monomers which are typically used to form MSNPs. A PEG-containing silane is any silane which contains a PEG as one of the substituents and the remaining groups can facilitate the silane reacting with other silanes to produce MSNPs according to the present invention. Preferred PEG-containing silanes and/or zwitterionic-containing silanes which are used in the present invention to create PEGylated MSNPs include 2-[methoxy(polyethyleneoxy)propyl]trimethoxysilane (containing varying molecular weights of PEG ranging from about 100 to 10,000 average molecule weight, often about 200 to 5,000 average molecular weight, about 1,000-2,500 average molecular weight, about 1500-2000 average molecular weight) and 3-{[Dimethoxyl(3-trimethoxysilyl)propyl]ammonio)propane-1-sulfonate and mixtures thereof, among others. The term “PEGylated” may also refer to lipid bilayers which contain a portion of lipids which are PEGylated (from about 0.02% up to about 50%, about 0.1% to about 35%, about 0.5% to about 25%, about 1% to about 15%, about 0.5% to about 7.5%, about 1% to about 12.5% by weight of the lipids used to form the lipid bilayer or multilayer). These lipids often are amine-containing lipids (e.g. DOPE and DPPE) which are conjugated or derivatized to contain a PEG group (having an average molecule weight ranging from about 100 to 10,000, about 200 to 5,000, about 1,000-5,000, including 1,000, 2000, 3000 and 3400) and combined with other lipids to form the bilayer/multilayer which encapsulates the MSNP.

“Amine-containing silanes” include, but are not limited to, a primary amine, a secondary amine or a tertiary amine functionalized with a silicon atom, and may be a monoamine or a polyamine such as diamine. These silanes may be included in the precursor solutions without disrupting the phases which are created through the use of an appropriate surfactant combination to provide amine groups to the mesoporous materials and change the zeta potential of the mesoporous materials (making it somewhat more positive than when only silanes are used as precursors). Preferably, the amine-containing silane is N-(2-aminoethyl)-3-aminopropyltrimethoxysilane (AEPTMS). Non-limiting examples of amine-containing silanes also include 3-aminopropyltrimethoxysilane (APTMS) and 3-aminopropyltriethoxysilane (APTS), as well as an amino-functional trialkoxysilane. Protonated secondary amines, protonated tertiary alkyl amines, protonated amidines, protonated guanidines, protonated pyridines, protonated pyrimidines, protonated pyrazines, protonated purines, protonated imidazoles, protonated pyrroles, quaternary alkyl amines, or combinations thereof, can also be used. These are used to modify the charge (Zeta potential) of the nanoparticle, which typically has a negative Zeta charge to something which is more neutral or even more positive in character.

MSNPs as described herein may optionally contain a lipid bilayer which coats the surface of the MSNP. These MSNPs which contain lipid bilayer are referred to as “protocells”. In general, protocells according to the present invention are biocompatible. Drugs and other cargo components are often loaded by adsorption and/or capillary filling of the pores of the particle core up to approximately 50% by weight of the final protocell (containing all components). In certain embodiments according to the present invention, the loaded cargo can be released from the porous surface of the particle core (mesopores), wherein the release profile can be determined or adjusted by, for example, the pore size, the surface chemistry of the porous particle core, the pH value of the system, and/or the interaction of the porous particle core with the surrounding lipid bilayer(s) as generally described herein.

In the present invention, the porous nanoparticle core used to prepare the protocells can be tuned in to be hydrophilic or progressively more hydrophobic as otherwise described herein and can be further treated to provide a more hydrophilic surface (often additional SiOH groups are produced, as well as other hydrophilic groups). For example, mesoporous silica particles according to the present invention can be further treated with ammonium hydroxide and hydrogen peroxide to provide a higher hydrophilicity. In preferred aspects of the invention, the lipid bilayer is fused onto the porous particle core to form the protocell. Protocells according to the present invention can include various lipids in various weight ratios, preferably including 1,2-dioleoyl-sn-glycero-3-phosphocholine (DOPC), 1,2-dipalmitoyl-sn-glycero-3-phosphocholine (DPPC), 1,2-distearoyl-sn-glycero-3-phosphocholine (DSPC), 1,2-dioleoyl-sn-glycero-3-[phosphor-L-serine] (DOPS), 1,2-dioleoyl-3-trimethylammonium-propane (18:1 DOTAP), 1,2-dioleoyl-sn-glycero-3-phospho-(1′-rac-glycerol) (DOPG), 1,2-dioleoyl-sn-glycero-3-phosphoethanolamine (DOPE), 1,2-dipalmitoyl-sn-glycero-3-phosphoethanolamine (DPPE), 1,2-dioleoyl-sn-glycero-3-phosphoethanolamine-N-[methoxy(polyethylene glycol)-2000] (18:1 PEG-2000 PE), 1,2-dipalmitoyl-sn-glycero-3-phosphoethanolamine-N-[methoxy(polyethylene glycol)-2000] (16:0 PEG-2000 PE), 1-Oleoyl-2-[12-[(7-nitro-2-1,3-benzoxadiazol-4-yl)amino]lauroyl]-sn-Glycero-3-Phosphocholine (18:1-12:0 NBD PC), 1-palmitoyl-2-{12-[(7-nitro-2-1,3-benzoxadiazol-4-yl)amino]lauroyl}-sn-glycero-3-phosphocholine (16:0-12:0 NBD PC), cholesterol and mixtures/combinations thereof.

Pegylated phospholipids may be included in lipid bilayers in protocells according to the present invention. These pegylated phospholipids include for example, pegylated 1,2-distearoyl-sn-glycero-3-phosphoethanolamine (PEG-DSPE), pegylated 1,2-dioleoyl-sn-glycero-3-phosphoethanolamine (PEG-DOPE), pegylated 1,2-dipalmitoyl-sn-glycero-3-phosphoethanolamine (PEG-DPPE), and pegylated 1,2-dimyristoyl-sn-glycero-3-phosphoethanolamine (PEG-DMPE), among others, including a pegylated ceramide (e.g. N-octanoyl-sphingosine-1-succinylmethoxy-PEG or N-palmitoyl-sphingosine-1-succinylmethoxy-PEG, among others). The PEG generally ranges in size (average molecular weight for the PEG group) from about 350-7500, about 350-5000, about 500-2500, about 1000-2000. Pegylated phospholipids may comprise the entire phospholipid monolayer of hybrid phospholipid protocells according to the present invention, or alternatively they may comprise a minor component of the lipid monolayer or be absent. Accordingly, the percent by weight of a pegylated phospholipid in phospholipid monolayers which make up the present invention ranges from 0% to 100%, 0.01% to 99%, about 5%, 10%, 15%, 20%, 25%, 30%, 35%, 40%, 50%, 55%, 60% and the remaining portion of the phospholipid monolayer comprising at least one additional lipid (such as cholesterol, usually in amounts less than about 50% by weight), including a phospholipid.

Certain lipid combinations for use in the present invention are often used. These include, for example, DSPC/DOPE/Cholesterol (60/30/10 mass %), DSPC/DOPE/Cholesterol/DSPE-PEG 2000 (60/15/15/10 mass %), and DSPC/DSPE/Cholesterol/DSPE-PEG 2000 (60/15/15/10), among other combinations. The inclusion of a PEG moiety for purposes of increasing residence time and/or bioavailability of the protocells after administration may be preferred.

The lipid bilayer which is used to prepare protocells according to the present invention can be prepared, for example, by extrusion of hydrated lipid films through a filter with pore size of, for example, about 100 nm, using standard protocols known in the art or as otherwise described herein. The filtered lipid bilayer films can then be fused with the porous particle cores, for example, by pipette mixing. In certain embodiments, excess amount of lipid bilayer or lipid bilayer films can be used to form the protocell in order to improve the protocell colloidal stability.

The terms “targeting ligand” and “targeting active species” are used to describe a compound or moiety (preferably an antigen) which is complexed or preferably covalently bonded to the surface of a MSNPs and/or protocells according to the present invention which binds to a moiety on the surface of a cell to be targeted so that the MSNPs and/or protocells may selectively bind to the surface of the targeted cell and deposit their contents into the cell. The targeting active species for use in the present invention is preferably a targeting peptide as otherwise described herein, a polypeptide including an antibody or antibody fragment, an aptamer, or a carbohydrate, among other species which bind to a targeted cell.

Preferred ligands which may be used to target cells include peptides, affibodies and antibodies (including monoclonal and/or polyclonal antibodies). In certain embodiments, targeting ligands selected from the group consisting of Fcγ from human IgG (which binds to Fcγ receptors on macrophages and dendritic cells), human complement C3 (which binds to CR1 on macrophages and dendritic cells), ephrin B2 (which binds to EphB4 receptors on alveolar type II epithelial cells), and the SP94 peptide (which binds to unknown receptor(s) on hepatocyte-derived cells). Targeting ligands in certain aspects of the invention target T-Cell for therapy.

The charge is controlled based on what is to be accomplished (via PEI, NMe3+, dye, crosslinker, ligands, etc.), but for targeting the charge is preferably cationic. Charge also changes throughout the process of formation. Initially the targeted particles are cationic and are often delivered as cationically charged nanoparticles, however post modification with ligands they are closer to neutral. The ligands which find use in the present invention include peptides, affibodies and antibodies, among others. These ligands are site specific and are useful for targeting specific cells which express peptides to which the ligand may bind selectively to targeted cells.

MSNPs pursuant to the present invention may be used to deliver cargo to a targeted cell, including, for example, cargo component selected from the group consisting of at least one polynucleotide, such as double stranded linear DNA, minicircle DNA, naked DNA or plasmid DNA, messenger RNA, small interfering RNA, small hairpin RNA, microRNA, a polypeptide, a protein, a drug (in particular, an anticancer drug such as a chemotherapeutic agent), an imaging agent, or a mixture thereof. The MSNPs pursuant to the present invention are effective for accommodating cargo which are long and thin (e.g. naked) in three-dimensional structure, such as polynucleotides (e.g. various DNA and RNA) and polypeptides.

In protocells of the invention, a PEGylated lipid bi- or multilayer encapsulates a population of MSNPs as described herein and comprises (1) a PEGylated lipid which is optionally-thiolated (2) at least one additional lipid and, optionally (3) at least one targeting ligand which is conjugated to the outer surface of the lipid bi- or multilayer and which is specific against one or more receptors of white blood cells and arterial, venous and/or capillary vessels or combinations thereof, or which is specific against one or more receptors of targets a cancer cell, a bacterium, or a virus.

Protocells of the invention are highly flexible and modular. High concentrations of physiochemically-disparate molecules can be loaded into the protocells and their therapeutic and/or diagnostic agent release rates can be optimized without altering the protocell's size, size distribution, stability, or synthesis strategy. Properties of the supported lipid bi- or multilayer and mesoporous silica nanoparticle core can also be modulated independently, thereby optimizing properties as surface charge, colloidal stability, and targeting specificity independently from overall size, type of cargo(s), loading capacity, and release rate.

The terms “treat”, “treating”, and “treatment”, are used synonymously to refer to any action providing a benefit to a patient at risk for or afflicted with a disease, including improvement in the condition through lessening, inhibition, suppression or elimination of at least one symptom, delay in progression of the disease, prevention, delay in or inhibition of the likelihood of the onset of the disease, etc. In the case of viral infections, these terms also apply to viral infections and preferably include, in certain particularly favorable embodiments the eradication or elimination (as provided by limits of diagnostics) of the virus which is the causative agent of the infection.

The term “pharmaceutically acceptable” as used herein means that the compound or composition is suitable for administration to a subject, including a human patient, to achieve the treatments described herein, without unduly deleterious side effects in light of the severity of the disease and necessity of the treatment.

Treatment, as used herein, encompasses both prophylactic and therapeutic treatment, principally of cancer, but also of other disease states, including bacterial and viral infections, (e.g. HBV and/or HCV). Compounds according to the present invention can, for example, be administered prophylactically to a mammal in advance of the occurrence of disease to reduce the likelihood of that disease. Prophylactic administration is effective to reduce or decrease the likelihood of the subsequent occurrence of disease in the mammal, or decrease the severity of disease (inhibition) that subsequently occurs, especially including metastasis of cancer. Alternatively, compounds according to the present invention can, for example, be administered therapeutically to a mammal that is already afflicted by disease. In one embodiment of therapeutic administration, administration of the present compounds is effective to eliminate the disease and produce a remission or substantially eliminate the likelihood of metastasis of a cancer. Administration of the compounds according to the present invention is effective to decrease the severity of the disease or lengthen the lifespan of the mammal so afflicted, as in the case of cancer, or inhibit or even eliminate the causative agent of the disease, as in the case of hepatitis B virus (HBV) and/or hepatitis C virus infections (HCV) infections.

Our novel MSNPs and protocells can also be used to treat a wide variety of bacterial infections including, but not limited to, infections caused by bacteria selected from the group consisting of F. tularensis, B. pseudomallei, Mycobacterium, staphylococcus, streptococcaceae, neisseriaaceae, cocci, enterobacteriaceae, pseudomonadaceae, vibrionaceae, campylobacter, pasteurellaceae, bordetella, francisella, brucella, legionellaceae, bacteroidaceae, gram-negative bacilli, clostridium, corynebacterium, propionibacterium, gram-positive bacilli, anthrax, actinomyces, nocardia, mycobacterium, treponema, borrelia, leptospira, mycoplasma, ureaplasma, rickettsia, chlamydiae and P. aeruginosa.

Antibiotic MSNPs and protocells of the invention can contain one or more antibiotics, e.g. “Antibiotics” include, but are not limited to, compositions selected from the group consisting of Gentamicin, Kanamycin, Neomycin, Netilmicin, Tobramycin, Paromomycin, Spectinomycin, Geldanamycin, Herbimycin, Rifaximin, Streptomycin, Ertapenem, Doripenem, Imipenem/Cilastatin, Meropenem, Cefadroxil, Cefazolin, Cephalothin, Cephalexin, Cefaclor, Cefamandole, Cefoxitin, Cefprozil, Cefuroxime, Cefixime, Cefdinir, Cefditoren, Cefoperazone Cefotaxime, Cefpodoxime, Ceftazadime, Ceftibuten, Ceftizoxime Ceftriaxone, Cefepime, Ceftaroline fosamil, Ceftobiprole, Teicoplanin, Vancomycin, Telavancin, Daptomycin, Oritavancin, WAP-8294A, Azithromycin, Clarithromycin, Dirithromycin, Erythromycin, Roxithromycin, Telithromycin, Spiramycin, Clindamycin, Lincomycin, Aztreonam, Furazolidone, Nitrofurantoin, Oxazolidonones, Linezolid, Posizolid, Radezolid, Torezolid, Amoxicillin, Ampicillin, Azlocillin, Carbenicillin, Cloxacillin Dicloxacillin, Flucloxacillin, Mezlocillin, Methicillin, Nafcillin, Oxacillin, Penicillin G, Penicillin V, Piperacillin, Temocillin, Ticarcillin, Amoxicillin/clavulanate, Ampicillin/sulbactam, Piperacillin/tazobactam, Ticarcillin/clavulanate, Bacitracin, Colistin, Polymyxin B, Ciprofloxacin, Enoxacin, Gatifloxacin, Gemifloxacin, Levofloxacin, Lomefloxacin, Moxifloxacin, Nalidixic acid, Norfloxacin, Ofloxacin, Trovafloxacin, Grepafloxacin, Sparfloxacin, Mafenide, Sulfacetamide, Sulfadiazine, Sulfadimethoxine, Sulfamethizole, Sulfamethoxazole, Sulfasalazine, Sulfisoxazole, Trimethoprim-Sulfamethoxazole, Sulfonamidochrysoidine, Demeclocycline, Doxycycline, Vibramycin Minocycline, Tigecycline, Oxytetracycline, Tetracycline, Clofazimine, Capreomycin, Cycloserine, Ethambutol, Rifampicin, Rifabutin, Rifapentine, Arsphenamine, Chloramphenicol, Fosfomycin, Fusidic acid, Metronidazole, Mupirocin, Platensimycin, Quinupristin/Dalfopristin, Thiamphenicol, Tigecycline and Tinidazole and combinations thereof.

The term “neoplasia” refers to the uncontrolled and progressive multiplication of tumor cells, under conditions that would not elicit, or would cause cessation of, multiplication of normal cells. Neoplasia results in a “neoplasm”, which is defined herein to mean any new and abnormal growth, particularly a new growth of tissue, in which the growth of cells is uncontrolled and progressive. Thus, neoplasia includes “cancer”, which herein refers to a proliferation of tumor cells having the unique trait of loss of normal controls, resulting in unregulated growth, lack of differentiation, local tissue invasion, and/or metastasis.

As used herein, neoplasms include, without limitation, morphological irregularities in cells in tissue of a subject or host, as well as pathologic proliferation of cells in tissue of a subject, as compared with normal proliferation in the same type of tissue. Additionally, neoplasms include benign tumors and malignant tumors (e.g., colon tumors) that are either invasive or noninvasive. Malignant neoplasms are distinguished from benign neoplasms in that the former show a greater degree of anaplasia, or loss of differentiation and orientation of cells, and have the properties of invasion and metastasis. Examples of neoplasms or neoplasias from which the target cell of the present invention may be derived include, without limitation, carcinomas (e.g., squamous-cell carcinomas, adenocarcinomas, hepatocellular carcinomas, and renal cell carcinomas), particularly those of the bladder, bowel, breast, cervix, colon, esophagus, head, kidney, liver, lung, neck, ovary, pancreas, prostate, and stomach; leukemias; benign and malignant lymphomas, particularly Burkitt's lymphoma and Non-Hodgkin's lymphoma; benign and malignant melanomas; myeloproliferative diseases; sarcomas, particularly Ewing's sarcoma, hemangiosarcoma, Kaposi's sarcoma, liposarcoma, myosarcomas, peripheral neuroepithelioma, and synovial sarcoma; tumors of the central nervous system (e.g., gliomas, astrocytomas, oligodendrogliomas, ependymomas, gliobastomas, neuroblastomas, ganglioneuromas, gangliogliomas, medulloblastomas, pineal cell tumors, meningiomas, meningeal sarcomas, neurofibromas, and Schwannomas); germ-line tumors (e.g., bowel cancer, breast cancer, prostate cancer, cervical cancer, uterine cancer, lung cancer, ovarian cancer, testicular cancer, thyroid cancer, astrocytoma, esophageal cancer, pancreatic cancer, stomach cancer, liver cancer, colon cancer, and melanoma); mixed types of neoplasias, particularly carcinosarcoma and Hodgkin's disease; and tumors of mixed origin, such as Wilms' tumor and teratocarcinomas (Beers and Berkow (eds.), The Merck Manual of Diagnosis and Therapy, 17.sup.th ed. (Whitehouse Station, N.J.: Merck Research Laboratories, 1999) 973-74, 976, 986, 988, 991.

The term “additional anticancer agent” shall mean chemotherapeutic agents such as an agent selected from the group consisting of microtubule-stabilizing agents, microtubule-disruptor agents, alkylating agents, antimetabolites, epidophyllotoxins, antineoplastic enzymes, topoisomerase inhibitors, inhibitors of cell cycle progression, and platinum coordination complexes. These may be selected from the group consisting of everolimus, trabectedin, abraxane, TLK 286, AV-299, DN-101, pazopanib, GSK690693, RTA 744, ON 0910.Na, AZD 6244 (ARRY-142886), AMN-107, TKI-258, GSK461364, AZD 1152, enzastaurin, vandetanib, ARQ-197, MK-0457, MLN8054, PHA-739358, R-763, AT-9263, a FLT-3 inhibitor, a VEGFR inhibitor, an EGFR TK inhibitor, an aurora kinase inhibitor, a PIK-1 modulator, a Bcl-2 inhibitor, an HDAC inhbitor, a c-MET inhibitor, a PARP inhibitor, a Cdk inhibitor, an EGFR TK inhibitor, an IGFR-TK inhibitor, an anti-HGF antibody, a PI3 kinase inhibitors, an AKT inhibitor, a JAK/STAT inhibitor, a checkpoint-1 or 2 inhibitor, a focal adhesion kinase inhibitor, a Map kinase kinase (mek) inhibitor, a VEGF trap antibody, pemetrexed, erlotinib, dasatanib, nilotinib, decatanib, panitumumab, amrubicin, oregovomab, Lep-etu, nolatrexed, azd2171, batabulin, ofatumumab, zanolimumab, edotecarin, tetrandrine, rubitecan, tesmilifene, oblimersen, ticilimumab, ipilimumab, gossypol, Bio 111, 131-I-TM-601, ALT-110, BIO 140, CC 8490, cilengitide, gimatecan, IL13-PE38QQR, INO 1001, IPdR₁ KRX-0402, lucanthone, LY 317615, neuradiab, vitespan, Rta 744, Sdx 102, talampanel, atrasentan, Xr 311, romidepsin, ADS-100380, sunitinib, 5-fluorouracil, vorinostat, etoposide, gemcitabine, doxorubicin, liposomal doxorubicin, 5′-deoxy-5-fluorouridine, vincristine, temozolomide, ZK-304709, seliciclib; PD0325901, AZD-6244, capecitabine, L-Glutamic acid, N-[4-[2-(2-amino-4,7-dihydro-4-oxo-1H-pyrrolo[2,3-d]pyrimidin-5-yl)ethyl]benzoyl]-, disodium salt, heptahydrate, camptothecin, PEG-labeled irinotecan, tamoxifen, toremifene citrate, anastrazole, exemestane, letrozole, DES(diethylstilbestrol), estradiol, estrogen, conjugated estrogen, bevacizumab, IMC-1C11, CHIR-258); 3-[5-(methylsulfonylpiperadinemethyl)-indolylj-quinolone, vatalanib, AG-013736, AVE-0005, the acetate salt of [D-Ser(Bu t) 6, Azgly 10] (pyro-Glu-His-Trp-Ser-Tyr-D-Ser(Bu t)-Leu-Arg-Pro-Azgly-NH₂ acetate [C₅₉H₈₄N₁₈Oi₄-(C₂H₄O₂)ₓ where x=1 to 2.4], goserelin acetate, leuprolide acetate, triptorelin pamoate, medroxyprogesterone acetate, hydroxyprogesterone caproate, megestrol acetate, raloxifene, bicalutamide, flutamide, nilutamide, megestrol acetate, CP-724714; TAK-165, HKI-272, erlotinib, lapatanib, canertinib, ABX-EGF antibody, erbitux, EKB-569, PKI-166, GW-572016, Ionafarnib, BMS-214662, tipifarnib; amifostine, NVP-LAQ824, suberoyl analide hydroxamic acid, valproic acid, trichostatin A, FK-228, SU11248, sorafenib, KRN951, aminoglutethimide, amsacrine, anagrelide, L-asparaginase, Bacillus Calmette-Guerin (BCG) vaccine, bleomycin, buserelin, busulfan, carboplatin, carmustine, chlorambucil, cisplatin, cladribine, clodronate, cyproterone, cytarabine, dacarbazine, dactinomycin, daunorubicin, diethylstilbestrol, epirubicin, fludarabine, fludrocortisone, fluoxymesterone, flutamide, gemcitabine, hydroxyurea, idarubicin, ifosfamide, imatinib, leuprolide, levamisole, lomustine, mechlorethamine, melphalan, 6-mercaptopurine, mesna, methotrexate, mitomycin, mitotane, mitoxantrone, nilutamide, octreotide, oxaliplatin, pamidronate, pentostatin, plicamycin, porfimer, procarbazine, raltitrexed, rituximab, streptozocin, teniposide, testosterone, thalidomide, thioguanine, thiotepa, tretinoin, vindesine, 13-cis-retinoic acid, phenylalanine mustard, uracil mustard, estramustine, altretamine, floxuridine, 5-deooxyuridine, cytosine arabinoside, 6-mecaptopurine, deoxycoformycin, calcitriol, valrubicin, mithramycin, vinblastine, vinorelbine, topotecan, razoxin, marimastat, COL-3, neovastat, BMS-275291, squalamine, endostatin, SU5416, SU6668, EMD121974, interleukin-12, IM862, angiostatin, vitaxin, droloxifene, idoxyfene, spironolactone, finasteride, cimitidine, trastuzumab, denileukin diftitox, gefitinib, bortezimib, paclitaxel, cremophor-free paclitaxel, docetaxel, epithilone B, BMS-247550, BMS-310705, droloxifene, 4-hydroxytamoxifen, pipendoxifene, ERA-923, arzoxifene, fulvestrant, acolbifene, lasofoxifene, idoxifene, TSE-424, HMR-3339, ZK186619, topotecan, PTK787/ZK 222584, VX-745, PD 184352, rapamycin, 40-O-(2-hydroxyethyl)-rapamycin, temsirolimus, AP-23573, RAD001, ABT-578, BC-210, LY294002, LY292223, LY292696, LY293684, LY293646, wortmannin, ZM336372, L-779, 450, PEG-filgrastim, darbepoetin, erythropoietin, granulocyte colony-stimulating factor, zolendronate, prednisone, cetuximab, granulocyte macrophage colony-stimulating factor, histrelin, pegylated interferon alfa-2a, interferon alfa-2a, pegylated interferon alfa-2b, interferon alfa-2b, azacitidine, PEG-L-asparaginase, lenalidomide, gemtuzumab, hydrocortisone, interleukin-11, dexrazoxane, alemtuzumab, all-transretinoic acid, ketoconazole, interleukin-2, megestrol, immune globulin, nitrogen mustard, methylprednisolone, ibritgumomab tiuxetan, androgens, decitabine, hexamethylmelamine, bexarotene, tositumomab, arsenic trioxide, cortisone, editronate, mitotane, cyclosporine, liposomal daunorubicin, Edwina-asparaginase, strontium 89, casopitant, netupitant, an NK-1 receptor antagonists, palonosetron, aprepitant, diphenhydramine, hydroxyzine, metoclopramide, lorazepam, alprazolam, haloperidol, droperidol, dronabinol, dexamethasone, methylprednisolone, prochlorperazine, granisetron, ondansetron, dolasetron, tropisetron, pegfilgrastim, erythropoietin, epoetin alfa and darbepoetin alfa, among others.

MSNPs and protocells of the invention can comprise anti-cancer agents selected from the group consisting of doxorubicin-loaded liposomes that are functionalized by polyethylene glycol (PEG), antimetabolites, inhibitors of topoisomerase I and II, alkylating agents and microtubule inhibitors, adriamycin aldesleukin; alemtuzumab; alitretinoin; allopurinol; altretamine; amifostine; anastrozole; arsenic trioxide; Asparaginase; BCG Live; bexarotene capsules; bexarotene gel; bleomycin; busulfan intravenous; busulfan oral; calusterone; capecitabine; carboplatin; carmustine; carmustine with Polifeprosan 20 Implant; celecoxib; chlorambucil; cisplatin; cladribine; cyclophosphamide; cytarabine; cytarabine liposomal; dacarbazine; dactinomycin; actinomycin D; Darbepoetin alfa; daunorubicin liposomal; daunorubicin, daunomycin; Denileukin diftitox, dexrazoxane; docetaxel; doxorubicin; doxorubicin liposomal; Dromostanolone propionate; Elliott's B Solution; epirubicin; Epoetin alfa estramustine; etoposide phosphate; etoposide (VP-16); exemestane; Filgrastim; floxuridine (intraarterial); fludarabine; fluorouracil (5-FU); fulvestrant; gemcitabine, gemtuzumab ozogamicin; goserelin acetate; hydroxyurea; Ibritumomab Tiuxetan; idarubicin; ifosfamide; imatinib mesylate; Interferon alfa-2a; Interferon alfa-2b; irinotecan; letrozole; leucovorin; levamisole; lomustine (CCNU); meclorethamine (nitrogen mustard); megestrol acetate; melphalan (L-PAM); mercaptopurine (6-MP); mesna; methotrexate; methoxsalen; mitomycin C; mitotane; mitoxantrone; nandrolone phenpropionate; Nofetumomab; LOddC; Oprelvekin; oxaliplatin; paclitaxel; pamidronate; pegademase; Pegaspargase; Pegfilgrastim; pentostatin; pipobroman; plicamycin; mithramycin; porfimer sodium; procarbazine; quinacrine; Rasburicase; Rituximab; Sargramostim; streptozocin; talbuvidine (LDT); talc; tamoxifen; temozolomide; teniposide (VM-26); testolactone; thioguanine (6-TG); thiotepa; topotecan; toremifene; Tositumomab; Trastuzumab; tretinoin (ATRA); uracil mustard; valrubicin; valtorcitabine (monoval LDC); vinblastine; vinorelbine; zoledronate; and mixtures thereof.

In certain embodiments, MSNPs and protocells of the invention comprise anti-cancer drugs selected from the group consisting of doxorubicin, melphalan, bevacizumab, dactinomycin, cyclophosphamide, doxorubicin liposomal, amifostine, etoposide, gemcitabine, altretamine, topotecan, cyclophosphamide, paditaxel, carboplatin, cisplatin, and taxol.

MSNPs and protocells of the invention can include one or more antiviral agents to treat viral infections, especially including HIV infections, HBV infections and/or HCV infections. Exemplary anti-HIV agents include, for example, nucleoside reverse transcriptase inhibitors (NRTI), non-nucloeoside reverse transcriptase inhibitors (NNRTI), protease inhibitors, fusion inhibitors, among others, exemplary compounds of which may include, for example, 3TC (Lamivudine), AZT (Zidovudine), (−)-FTC, ddI (Didanosine), ddC (zalcitabine), abacavir (ABC), tenofovir (PMPA), D-D4FC (Reverset), D4T (Stavudine), Racivir, L-FddC, L-FD4C, NVP (Nevirapine); DLV (Delavirdine), EFV (Efavirenz), SQVM (Saquinavir mesylate), RTV (Ritonavir), IDV (Indinavir), SQV (Saquinavir), NFV (Nelfinavir), APV (Amprenavir), LPV (Lopinavir), fusion inhibitors such as T20, among others, fuseon and mixtures thereof, including anti-HIV compounds presently in clinical trials or in development. Exemplary anti-HBV agents include, for example, hepsera (adefovir dipivoxil), lamivudine, entecavir, telbivudine, tenofovir, emtricitabine, clevudine, valtoricitabine, amdoxovir, pradefovir, racivir, BAM 205, nitazoxanide, UT 231-B, Bay 41-4109, EHT899, zadaxin (thymosin alpha-1) and mixtures thereof. Anti-HCV agents include, for example, interferon, pegylated intergeron, ribavirin, NM 283, VX-950 (telaprevir), SCH 50304, TMC435, VX-500, BX-813, SCH503034, R1626, ITMN-191 (R7227), R7128, PF-868554, TT033, CGH-759, GI 5005, MK-7009, SIRNA-034, MK-0608, A-837093, GS 9190, ACH-1095, GSK625433, TG4040 (MVA-HCV), A-831, F351, NS5A, NS4B, ANA598, A-689, GNI-104, IDX102, ADX184, GL59728, GL60667, PSI-7851, TLR9 Agonist, PHX1766, SP-30 and mixtures thereof.

MSNPs and protocells of the invention can also be used to diagnose and treat a “vascular disorder”. A “vascular disorder” includes but is not limited to ischemic stroke, hemorrhagic stroke, transient ischemic attack (TIA), vascular inflammation due to meningitis, atherosclerosis, thrombi or emboli resulting from atherosclerosis, arteritis, physical obstruction of arterial blood supply to the brain, lacunar stroke, hypoperfusion emboding diffuse injury caused by non-localized cerebral ischemia, myocardial infarction and arrhythmia, restenosis associated with percutaneous transluminal coronary angioplasty, peripheral vascular disease and cerebral vascular disease, venous occlusive disorders such as deep vein thrombosis, and hypercoagulopathies. Vascular disease treatments include but are not limited to treatment of peripheral artery diseases (e.g. with cholesterol-lowering medications, high blood pressure medications, medication to control blood sugar, medications to prevent blood clots, symptom-relief medications, angioplasty and surgery, thrombolytic therapy and supervised exercise programs), cerebrovascular disorder treatments (e.g. aspirin, TPA, mechanical clot removal, carotid endarterectomy, angioplasty and stents), treatment of atherosclerosis (e.g. cholesterol medications, anti-platelet medications, beta blocker medications, angiotensin-converting enzyme (ACE) inhibitors, calcium channel blockers, water pills (diuretics), angioplasty, endarterectomy, thrombolytic therapy, and bypass surgery).

Typically the MSNPs and protocells according to the present invention are loaded with cargo to a capacity up to about 50 weight % or more (from about 0.01% to about 50%, about 0.02% to about 40%, about 0.2 to about 35%, about 0.5% to about 25%, about 1% to about 25%, about 1.5% to about 15%, about 0.1% to about 10%, about 0.01% to about 5%): defined as (cargo weight/weight of loaded protocell)×100. The optimal loading of cargo is often about 0.01 to 10% but this depends on the drug or drug combination which is incorporated as cargo into the MSNPs. This is generally expressed in μM per 10¹⁰ particles where we have values ranging from 2000-100 μM per 10¹⁰ particles. Preferred MSNPs according to the present invention exhibit release of cargo at pH about 5.5, which is that of the endosome, but are stable at physiological pH of 7 or higher (7.4).

The surface area of the internal space for loading is the pore volume which may vary considerably as a function of the pores within a given phase of the MSNPs but whose optimal value ranges from about 1.1 to 0.5 cubic centimeters per gram (cc/g). Note that in the MSNPs according to one embodiment of the present invention, the surface area is mainly internal as opposed to the external geometric surface area of the nanoparticle.

The term “lipid” is used to describe the components which are used to form lipid bi- or multilayers on the surface of the nanoparticles which are used in the present invention and may include a PEGylated lipid. Various embodiments provide nanostructures which are constructed from nanoparticles which support a lipid bilayer(s). In embodiments according to the present invention, the nanostructures preferably include, for example, a core-shell structure including a porous particle core surrounded by a shell of lipid bilayer(s). The nanostructure, preferably a porous alum nanostructure as described above, supports the lipid bilayer membrane structure.

The lipid bi- or multilayer supported on the porous particle according to one embodiment of the present invention has a lower melting transition temperature, i.e. is more fluid than a lipid bi- or multilayer supported on a non-porous support or the lipid bi- or multilayer in a liposome. This is sometimes important in achieving high affinity binding of immunogenic peptides or targeting ligands at low peptide densities, as it is the bilayer fluidity that allows lateral diffusion and recruitment of peptides by target cell surface receptors. One embodiment provides for peptides to cluster, which facilitates binding to a complementary target.

In the present invention, the lipid bi- or multilayer may vary significantly in composition. Ordinarily, any lipid or polymer which may be used in liposomes may also be used in MSNPs according to the present invention. Preferred lipids are as otherwise described herein.

In embodiments according to the invention, the lipid bi- or multilayer of the protocells can provide biocompatibility and can be modified to possess targeting species including, for example, antigens, targeting peptides, fusogenic peptides, antibodies, aptamers, and PEG (polyethylene glycol) to allow, for example, further stability of the protocells and/or a targeted delivery into a cell to maximize an immunogenic response. PEG, when included in lipid bilayers, can vary widely in molecular weight (although PEG ranging from about 10 to about 100 units of ethylene glycol, about 15 to about 50 units, about 15 to about 20 units, about 15 to about 25 units, about 16 to about 18 units, etc, may be used) and the PEG component which is generally conjugated to phospholipid through an amine group comprises about 1% to about 20%, preferably about 5% to about 15%, about 10% by weight of the lipids which are included in the lipid bi- or multilayer. The PEG component is generally conjugated to an amine-containing lipid such as DOPE or DPPE or other lipid, but in alternative embodiments may also be incorporated into the MSNPs, through inclusion of a PEG containing silane.

Numerous lipids which are used in liposome delivery systems may be used to form the lipid bi- or multilayer on nanoparticles according to the present invention. Virtually any lipid which is used to form a liposome may be used in the lipid bi- or multilayer which surrounds the nanoparticles according to an embodiment of the present invention. Preferred lipids for use in the present invention in forming protocells according to the present invention include, for example, 1,2-dioleoyl-sn-glycero-3-phosphocholine (DOPC), 1,2-dipalmitoyl-sn-glycero-3-phosphocholine (DPPC), 1,2-distearoyl-sn-glycero-3-phosphocholine (DSPC), 1,2-dioleoyl-sn-glycero-3-[phosphor-L-serine] (DOPS), 1,2-dioleoyl-3-trimethylammonium-propane (18:1 DOTAP), 1,2-dioleoyl-sn-glycero-3-phospho-(1′-rac-glycerol) (DOPG), 1,2-dioleoyl-sn-glycero-3-phosphoethanolamine (DOPE), 1,2-dipalmitoyl-sn-glycero-3-phosphoethanolamine (DPPE), 1,2-dioleoyl-sn-glycero-3-phosphoethanolamine-N-[methoxy(polyethylene glycol)-2000] (18:1 PEG-2000 PE), 1,2-dipalmitoyl-sn-glycero-3-phosphoethanolamine-N-[methoxy(polyethylene glycol)-2000] (16:0 PEG-2000 PE), 1-Oleoyl-2-[12-[(7-nitro-2-1,3-benzoxadiazol-4-yl)amino]lauroyl]-sn-Glycero-3-Phosphocholine (18:1-12:0 NBD PC), 1-palmitoyl-2-{12-[(7-nitro-2-1,3-benzoxadiazol-4-yl)amino]lauroyl}-sn-glycero-3-phosphocholine (16:0-12:0 NBD PC), cholesterol and mixtures/combinations thereof. Cholesterol, not technically a lipid, but presented as a lipid for purposes of an embodiment of the present invention given the fact that cholesterol may be an important component of the lipid bilayer of protocells according to an embodiment of the invention. Often cholesterol is incorporated into lipid bilayers of protocells in order to enhance structural integrity of the bilayer. These lipids are all readily available commercially from Avanti Polar Lipids, Inc. (Alabaster, Ala., USA). DOPE and DPPE are particularly useful for conjugating (through an appropriate crosslinker) PEG, peptides, polypeptides, including immunogenic peptides, proteins and antibodies, RNA and DNA through the amine group on the lipid.

MSNPs and protocells of the invention can be PEGylated with a variety of polyethylene glycol-containing compositions as described herein. PEG molecules can have a variety of lengths and molecular weights and include, but are not limited to, PEG 200, PEG 1000, PEG 1500, PEG 4600, PEG 10,000, PEG-peptide conjugates or combinations thereof.

The term “reporter” is used to describe an imaging agent or moiety which is incorporated into the phospholipid bilayer or cargo of MSNPs according to an embodiment of the present invention and provides a signal which can be measured. The moiety may provide a fluorescent signal or may be a radioisotope which allows radiation detection, among others. Exemplary fluorescent labels for use in MSNPs and protocells (preferably via conjugation or adsorption to the lipid bi- or multilayer or silica core, although these labels may also be incorporated into cargo elements such as DNA, RNA, polypeptides and small molecules which are delivered to cells by the protocells) include Hoechst 33342 (350/461), 4′,6-diamidino-2-phenylindole (DAPI, 356/451), Alexa Fluor® 405 carboxylic acid, succinimidyl ester (401/421), CellTracker™ Violet BMQC (415/516), CellTracker™ Green CMFDA (492/517), calcein (495/515), Alexa Fluor® 488 conjugate of annexin V (495/519), Alexa Fluor® 488 goat anti-mouse IgG (H+L) (495/519), Click-iT® AHA Alexa Fluor® 488 Protein Synthesis HCS Assay (495/519), LIVE/DEAD® Fixable Green Dead Cell Stain Kit (495/519), SYTOX® Green nucleic acid stain (504/523), MitoSOX™ Red mitochondrial superoxide indicator (510/580). Alexa Fluor® 532 carboxylic acid, succinimidyl ester (532/554), pHrodo™ succinimidyl ester (558/576), CellTracker™ Red CMTPX (577/602), Texas Red® 1,2-dihexadecanoyl-sn-glycero-3-phosphoethanolamine (Texas Red® DHPE, 583/608), Alexa Fluor® 647 hydrazide (649/666), Alexa Fluor® 647 carboxylic acid, succinimidyl ester (650/668), Ulysis™ Alexa Fluor® 647 Nucleic Acid Labeling Kit (650/670) and Alexa Fluor® 647 conjugate of annexin V (650/665). Moities which enhance the fluorescent signal or slow the fluorescent fading may also be incorporated and include SlowFade® Gold antifade reagent (with and without DAPI) and Image-iT® FX signal enhancer. All of these are well known in the art.

Additional reporters include polypeptide reporters which may be expressed by plasmids (such as histone-packaged supercoiled DNA plasmids) and include polypeptide reporters such as fluorescent green protein and fluorescent red protein. Reporters pursuant to the present invention are utilized principally in diagnostic applications including diagnosing the existence or progression of cancer (cancer tissue) in a patient and or the progress of therapy in a patient or subject.

Pharmaceutical compositions according to the present invention comprise an effective population of MSNPs and/or protocells as otherwise described herein formulated to effect an intended result (e.g. immunogenic result, therapeutic result and/or diagnostic analysis, including the monitoring of therapy) formulated in combination with a pharmaceutically acceptable carrier, additive or excipient. The MSNPs and/or protocells within the population of the composition may be the same or different depending upon the desired result to be obtained. Pharmaceutical compositions according to the present invention may also comprise an addition bioactive agent or drug, such as an antibiotic or antiviral agent.

Generally, dosages and routes of administration of the compound are determined according to the size and condition of the subject, according to standard pharmaceutical practices. Dose levels employed can vary widely, and can readily be determined by those of skill in the art. Typically, amounts in the milligram up to gram quantities are employed. The composition may be administered to a subject by various routes, e.g. orally, transdermally, perineurally or parenterally, that is, by intravenous, subcutaneous, intraperitoneal, intrathecal or intramuscular injection, among others, including buccal, rectal and transdermal administration. Subjects contemplated for treatment according to the method of the invention include humans, companion animals, laboratory animals, and the like. The invention contemplates immediate and/or sustained/controlled release compositions, including compositions which comprise both immediate and sustained release formulations. This is particularly true when different populations of MSNPs and/or protocells are used in the pharmaceutical compositions or when additional bioactive agent(s) are used in combination with one or more populations of protocells as otherwise described herein.

Formulations containing the compounds according to the present invention may take the form of liquid, solid, semi-solid or lyophilized powder forms, such as, for example, solutions, suspensions, emulsions, sustained-release formulations, tablets, capsules, powders, suppositories, creams, ointments, lotions, aerosols, patches or the like, preferably in unit dosage forms suitable for simple administration of precise dosages.

Pharmaceutical compositions according to the present invention typically include a conventional pharmaceutical carrier or excipient and may additionally include other medicinal agents, carriers, adjuvants, additives and the like. Preferably, the composition is about 0.1% to about 85%, about 0.5% to about 75% by weight of a compound or compounds of the invention, with the remainder consisting essentially of suitable pharmaceutical excipients.

An injectable composition for parenteral administration (e.g. intravenous, intramuscular or intrathecal) will typically contain the compound in a suitable i.v. solution, such as sterile physiological salt solution. The composition may also be formulated as a suspension in an aqueous emulsion.

Liquid compositions can be prepared by dissolving or dispersing the population of MSNPs and/or protocells (about 0.5% to about 20% by weight or more), and optional pharmaceutical adjuvants, in a carrier, such as, for example, aqueous saline, aqueous dextrose, glycerol, or ethanol, to form a solution or suspension. For use in an oral liquid preparation, the composition may be prepared as a solution, suspension, emulsion, or syrup, being supplied either in liquid form or a dried form suitable for hydration in water or normal saline.

For oral administration, such excipients include pharmaceutical grades of mannitol, lactose, starch, magnesium stearate, sodium saccharine, talcum, cellulose, glucose, gelatin, sucrose, magnesium carbonate, and the like. If desired, the composition may also contain minor amounts of non-toxic auxiliary substances such as wetting agents, emulsifying agents, or buffers.

When the composition is employed in the form of solid preparations for oral administration, the preparations may be tablets, granules, powders, capsules or the like. In a tablet formulation, the composition is typically formulated with additives, e.g. an excipient such as a saccharide or cellulose preparation, a binder such as starch paste or methyl cellulose, a filler, a disintegrator, and other additives typically used in the manufacture of medical preparations.

Methods for preparing such dosage forms are known or is apparent to those skilled in the art; for example, see Remington's Pharmaceutical Sciences (17th Ed., Mack Pub. Co., 1985). The composition to be administered will contain a quantity of the selected compound in a pharmaceutically effective amount for therapeutic use in a biological system, including a patient or subject according to the present invention.

Methods of treating patients or subjects in need for a particular disease state or infection comprise administration an effective amount of a pharmaceutical composition comprising therapeutic MSNPs and/or protocells and optionally at least one additional bioactive (e.g. antiviral) agent according to the present invention.

Diagnostic methods according to the present invention comprise administering to a patient in need an effective amount of a population of diagnostic MSNPs and/or protocells (e.g., MSNPs and/or protocells which comprise a target species, such as a targeting peptide which binds selectively to cancer cells and a reporter component to indicate the binding of the protocells) whereupon the binding of the MSNPs and/or protocells to cells as evidenced by the reporter component (moiety) will enable a diagnosis of the existence of a disease state in the patient.

An alternative of the diagnostic method of the present invention can be used to monitor the therapy of a disease state in a patient, the method comprising administering an effective population of diagnostic MSNPs and/or protocells (e.g., MSNPs and/or protocells which comprise a target species, such as a targeting peptide which binds selectively to target cells and a reporter component to indicate the binding of the protocells to cancer cells if the cancer cells are present) to a patient or subject prior to treatment, determining the level of binding of diagnostic protocells to target cells in said patient and during and/or after therapy, determining the level of binding of diagnostic protocells to target cells in said patient, whereupon the difference in binding before the start of therapy in the patient and during and/or after therapy will evidence the effectiveness of therapy in the patient, including whether the patient has completed therapy or whether the disease state has been inhibited or eliminated.

In accordance with the present invention there may be employed conventional molecular biology, microbiology, and recombinant DNA techniques within the skill of the art. Such techniques are explained fully in the literature. See, e.g., Sambrook et al, 2001, “Molecular Cloning: A Laboratory Manual”; Ausubel, ed., 1994, “Current Protocols in Molecular Biology” Volumes I-III; Celis, ed., 1994, “Cell Biology: A Laboratory Handbook” Volumes I-III; Coligan, ed., 1994, “Current Protocols in Immunology” Volumes I-III; Gait ed., 1984, “Oligonucleotide Synthesis”; Hames & Higgins eds., 1985, “Nucleic Acid Hybridization”; Hames & Higgins, eds., 1984, “Transcription And Translation”; Freshney, ed., 1986, “Animal Cell Culture”; IRL.

The term “histone-packaged supercoiled plasmid DNA” is used to describe a preferred component of protocells according to the present invention which utilize a preferred plasmid DNA which has been “supercoiled” (i.e., folded in on itself using a supersaturated salt solution or other ionic solution which causes the plasmid to fold in on itself and “supercoil” in order to become more dense for efficient packaging into the protocells). The plasmid may be virtually any plasmid which expresses any number of polypeptides or encode RNA, including small hairpin RNA/shRNA or small interfering RNA/siRNA, as otherwise described herein. Once supercoiled (using the concentrated salt or other anionic solution), the supercoiled plasmid DNA is then complexed with histone proteins to produce a histone-packaged “complexed” supercoiled plasmid DNA.

“Packaged” DNA herein refers to DNA that is loaded into protocells (either adsorbed into the pores or confined directly within the nanoporous silica core itself). To minimize the DNA spatially, it is often packaged, which can be accomplished in several different ways, from adjusting the charge of the surrounding medium to creation of small complexes of the DNA with, for example, lipids, proteins, or other nanoparticles (usually, although not exclusively cationic). Packaged DNA is often achieved via lipoplexes (i.e. complexing DNA with cationic lipid mixtures). In addition, DNA has also been packaged with cationic proteins (including proteins other than histones), as well as gold nanoparticles (e.g. NanoFlares—an engineered DNA and metal complex in which the core of the nanoparticle is gold).

Any number of histone proteins, as well as other means to package the DNA into a smaller volume such as normally cationic nanoparticles, lipids, or proteins, may be used to package the supercoiled plasmid DNA “histone-packaged supercoiled plasmid DNA”, but in therapeutic aspects which relate to treating human patients, the use of human histone proteins are preferably used. In certain aspects of the invention, a combination of human histone proteins H1, H2A, H2B, H3 and H4 in a preferred ratio of 1:2:2:2:2, although other histone proteins may be used in other, similar ratios, as is known in the art or may be readily practiced pursuant to the teachings of the present invention. The DNA may also be double stranded linear DNA, instead of plasmid DNA, which also may be optionally supercoiled and/or packaged with histones or other packaging components.

Other histone proteins which may be used in this aspect of the invention include, for example, H1F, H1F0, H1FNT, H1FOO, H1FX H1H1 HIST1H1A, HIST1H1B, HIST1H1C, HIST1H1D, HIST1H1E, HIST1H1T; H2AF, H2AFB1, H2AFB2, H2AFB3, H2AFJ, H2AFV, H2AFX, H2AFY, H2AFY2, H2AFZ, H2A1, HIST1H2AA, HIST1H2AB, HIST1H2AC, HIST1H2AD, HIST1H2AE, HIST1H2AG, HIST1H2AI, HIST1H2AJ, HIST1H2AK, HIST1H2AL, HIST1H2AM, H2A2, HIST2H2AA3, HIST2H2AC, H2BF, H2BFM, HSBFS, HSBFWT, H2B1, HIST1H2BA, HIST1HSBB, HIST1HSBC, HIST1HSBD, HIST1H2BE, HIST1H2BF, HIST1H2BG, HIST1H2BH, HIST1H2BI, HIST1H2BJ, HIST1H2BK, HIST1H2BL, HIST1H2BM, HIST1H2BN, HIST1H2BO, H2B2, HIST2H2BE, H3A1, HIST1H3A, HIST1H3B, HIST1H3C, HIST1H3D, HIST1H3E, HIST1H3F, HIST1H3G, HIST1H3H, HIST1H3I, HIST1H3J, H3A2, HIST2H3C, H3A3, HIST3H3, H41, HIST1H4A, HIST1H4B, HIST1H4C, HIST1H4D, HIST1H4E, HIST1H4F, HIST1H4G, HIST1H4H, HIST1H4I, HIST1H4J, HIST1H4K, HIST1H4L, H44 and HIST4H4.

The term “nuclear localization sequence” refers to a peptide sequence incorporated or otherwise crosslinked into histone proteins which comprise the histone-packaged supercoiled plasmid DNA. In certain embodiments, protocells according to the present invention may further comprise a plasmid (often a histone-packaged supercoiled plasmid DNA) which is modified (crosslinked) with a nuclear localization sequence (note that the histone proteins may be crosslinked with the nuclear localization sequence or the plasmid itself can be modified to express a nuclear localization sequence) which enhances the ability of the histone-packaged plasmid to penetrate the nucleus of a cell and deposit its contents there (to facilitate expression and ultimately cell death. These peptide sequences assist in carrying the histone-packaged plasmid DNA and the associated histones into the nucleus of a targeted cell whereupon the plasmid will express peptides and/or nucleotides as desired to deliver therapeutic and/or diagnostic molecules (polypeptide and/or nucleotide) into the nucleus of the targeted cell. Any number of crosslinking agents, well known in the art, may be used to covalently link a nuclear localization sequence to a histone protein (often at a lysine group or other group which has a nucleophilic or electrophilic group in the side chain of the amino acid exposed pendant to the polypeptide) which can be used to introduce the histone packaged plasmid into the nucleus of a cell. Alternatively, a nucleotide sequence which expresses the nuclear localization sequence can be positioned in a plasmid in proximity to that which expresses histone protein such that the expression of the histone protein conjugated to the nuclear localization sequence will occur thus facilitating transfer of a plasmid into the nucleus of a targeted cell.

Proteins gain entry into the nucleus through the nuclear envelope. The nuclear envelope consists of concentric membranes, the outer and the inner membrane. These are the gateways to the nucleus. The envelope consists of pores or large nuclear complexes. A protein translated with a NLS will bind strongly to importin (a.k.a. karyopherin), and together, the complex will move through the nuclear pore. Any number of nuclear localization sequences may be used to introduce histone-packaged plasmid DNA into the nucleus of a cell. Preferred nuclear localization sequences include H₂N-GNQSSNFGPMKGGNFGGRSSGPYGGGGQYFAKPRNQGGYGGC-COOH, RRMKWKK, PKKKRKV, and KR[PAATKKAGQA]KKKK, the NLS of nucleoplasmin, a prototypical bipartite signal comprising two clusters of basic amino acids, separated by a spacer of about 10 amino acids. Numerous other nuclear localization sequences are well known in the art. See, for example, LaCasse, et al., Nuclear localization signals overlap DNA- or RNA-binding domains in nucleic acid-binding proteins. Nucl. Acids Res., 23, 1647-1656 1995); Weis, K. Importins and exportins: how to get in and out of the nucleus [published erratum appears in Trends Biochem Sci 1998 July; 23(7):235]. TIBS, 23, 185-9 (1998); and Murat Cokol, Raj Nair & Burkhard Rost, “Finding nuclear localization signals”, at the website ubic.bioc.columbia.edu/papers/2000 nls/paper.html#tab2.

A “promoter sequence” is a DNA regulatory region capable of binding RNA polymerase in a cell and initiating transcription of a downstream (3′ direction) coding sequence. For purposes of defining the present invention, the promoter sequence is bounded at its 3′ terminus by the transcription initiation site and extends upstream (5′ direction) to include the minimum number of bases or elements necessary to initiate transcription at levels detectable above background. Within the promoter sequence will be found a transcription initiation, as well as protein binding domains (consensus sequences) responsible for the binding of RNA polymerase. Eukaryotic promoters will often, but not always, contain “TATA” boxes and “CAT” boxes. Prokaryotic promoters contain Shine-Dalgarno sequences in addition to the −10 and −35 consensus sequences.

An “expression control sequence” is a DNA sequence that controls and regulates the transcription and translation of another DNA sequence. A coding sequence is “under the control” of transcriptional and translational control sequences in a cell when RNA polymerase transcribes the coding sequence into mRNA, which is then translated into the protein encoded by the coding sequence. Transcriptional and translational control sequences are DNA regulatory sequences, such as promoters, enhancers, polyadenylation signals, terminators, and the like, that provide for the expression of a coding sequence in a host cell.

A “signal sequence” can be included before the coding sequence. This sequence encodes a signal peptide, N-terminal to the polypeptide, that communicates to the host cell to direct the polypeptide to the cell surface or secrete the polypeptide into the media, and this signal peptide is clipped off by the host cell before the protein leaves the cell. Signal sequences can be found associated with a variety of proteins native to prokaryotes and eukaryotes.

A nucleic acid molecule is “operatively linked” to, or “operably associated with”, an expression control sequence when the expression control sequence controls and regulates the transcription and translation of nucleic acid sequence. The term “operatively linked” includes having an appropriate start signal (e.g., ATG) in front of the nucleic acid sequence to be expressed and maintaining the correct reading frame to permit expression of the nucleic acid sequence under the control of the expression control sequence and production of the desired product encoded by the nucleic acid sequence. If a gene that one desires to insert into a recombinant DNA molecule does not contain an appropriate start signal, such a start signal can be inserted in front of the gene.

The invention is described further in the following non-limiting examples.

### Example 1

### Aerosol-Assisted Evaporation-Induced Self-Assembly (EISA) of MSNPs

Particles were synthesized using aerosol-assisted evaporation-induced self-assembly (EISA) as described previously (Lu, Y. F. and Brinker J. C. et al. Aerosol-assisted self-assembly of mesostructured spherical nanoparticles. Nature 398, 223-226 (1999)). Briefly, aqueous silica precursors (such as tetraethyl orthosilicate—TEOS or tetramethyl orthosilicate— TMOS) were added to a single-phase mixture of ethanol (or any other volatile solvent that is miscible with water, such as methanol) and water at approximately pH 2. Then surfactants were added directly to this mixture and sonicated to dissolve. Once diluted into this bulk liquid and dissolved, the liquid mixture appeared to have only one phase. To achieve multi-modal pore distributions, surfactant amounts were chosen such that after the evaporation of the ethanol/water phase, the resulting molar ratios of surfactants resulted in discrete phase separation. For the binary combination of CTAB and F127, two stable phases were found to exist at all molar ratios from 0.1% CTAB:F127 to 99.9% CTAB:F127. However, this apparent absolute immiscibility at all ratios of these two surfactants would not be expected for more chemically-similar surfactants (such as PEO-based block copolymers), as mixtures of these chemically-similar types of surfactants would be expected to have at least small molar composition ranges resulting in single, mixed phase (we investigated 50% F127:50% P123—this forms a single phase pore network). For these systems, it is especially important to choose molar ratios of surfactants that will result in multiple distinct phases after evaporation.

After preparing the single phase liquid mixture of ethanol, acidic water, and surfactants, the solution was aerosolized using nitrogen into a system with controlled volumes and temperature gradients designed to control the rate of evaporation relative to the time required for self-assembly. Appropriate volumes and temperatures must be found for each surfactant system that will yield multi-phase particles. After evaporation, particles were collected on a membrane filter. Surfactant was then extracted to yield porous particles using either calcination (where the temperature profile is set such as not to promote collapse of remaining pore structure—we used 500° C. for 8 hours for CTAB+F127) or solvent/acid liquid extraction. Porosity was then evaluated using nitrogen adsorption and transmission electron microscopy.

It is also possible to use this technique for ternary, quaternary, etc. surfactant mixtures. For example, we added 50% CTAB to the 50/50 mixture of F127 and P123. At these concentrations, the F127 and P123 form a stable mixed phase but the CTAB does not. The resulting particles resemble the F127+CTAB particles with two discrete phases of pores, but the F127+P123 phase displays larger pore diameter than when using just F127 alone. If desired, ratios of F127:P123 that phase separate could be used. After addition of CTAB, resulting particles will display 3 distinct pore structures with varying pore diameters—likely 6 nm pores formed from P123 discrete phase, surrounded by 5 nm pores formed by the P123+F127 mixed phase, surrounded by 4 nm pores formed by F127 discrete phase, finally surrounded by 2 nm pores formed by the CTAB discrete phase.

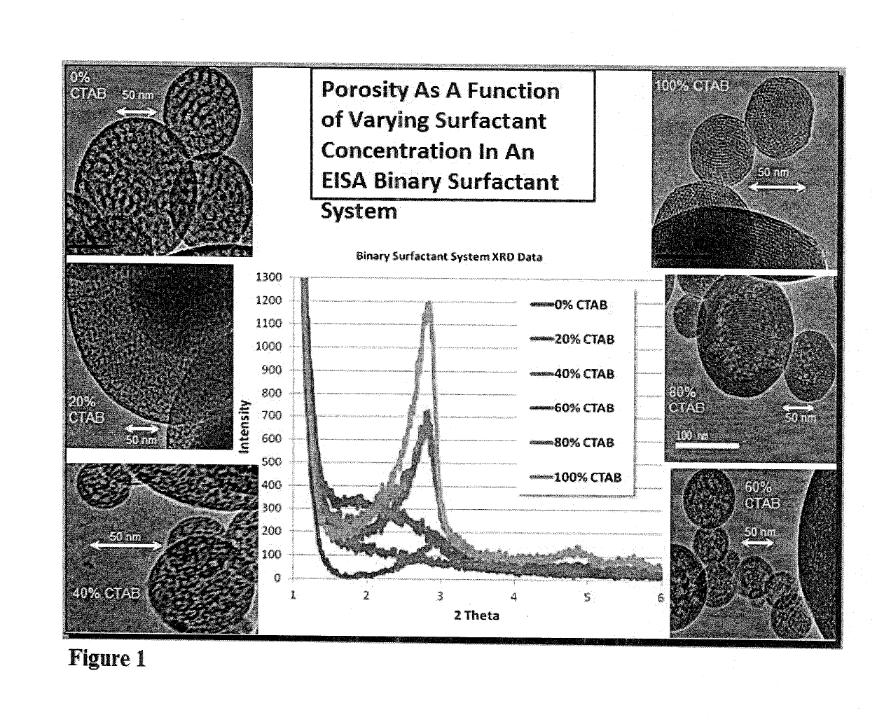

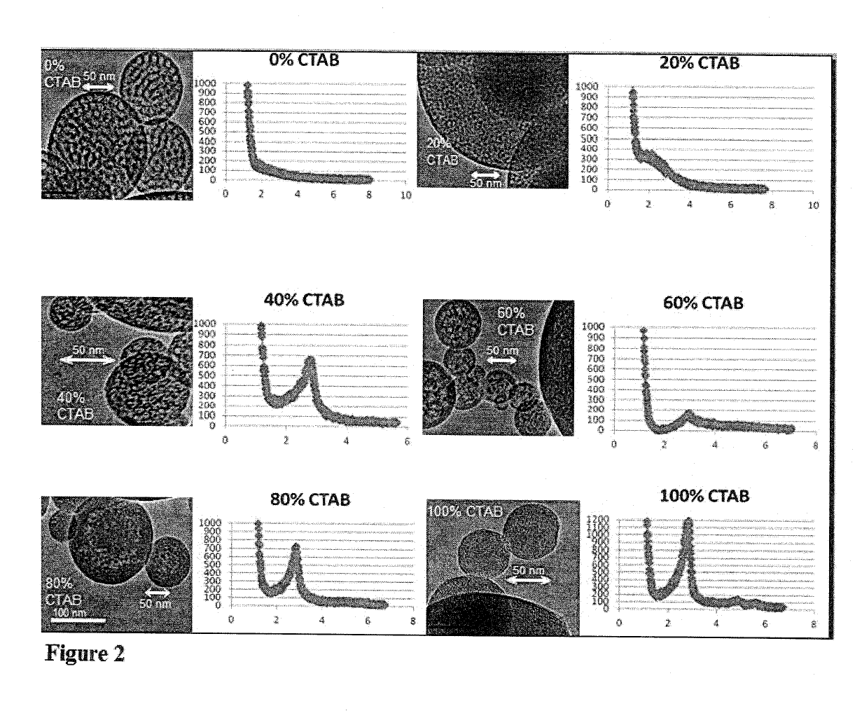

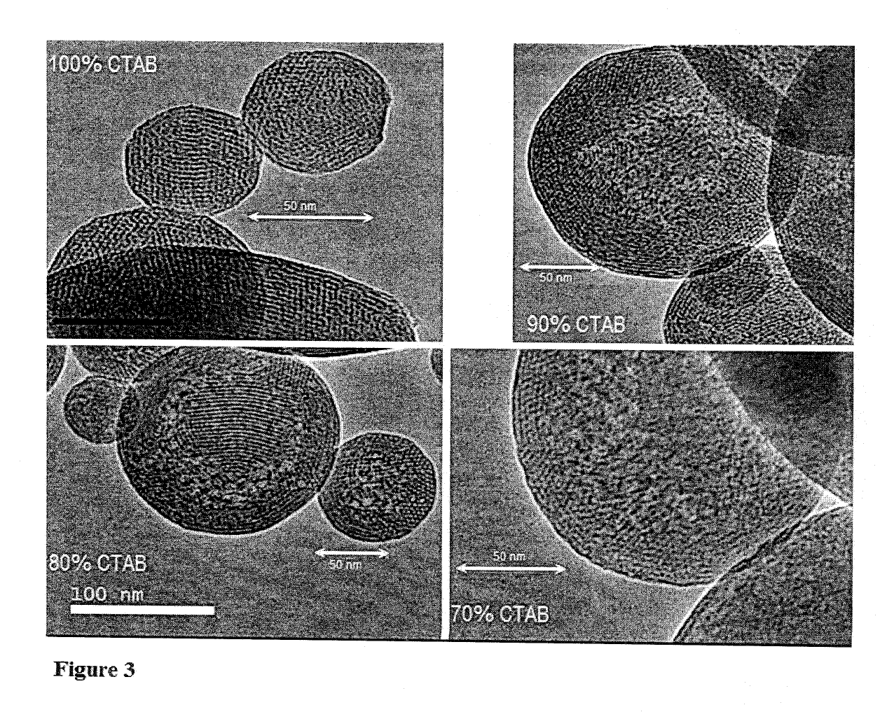

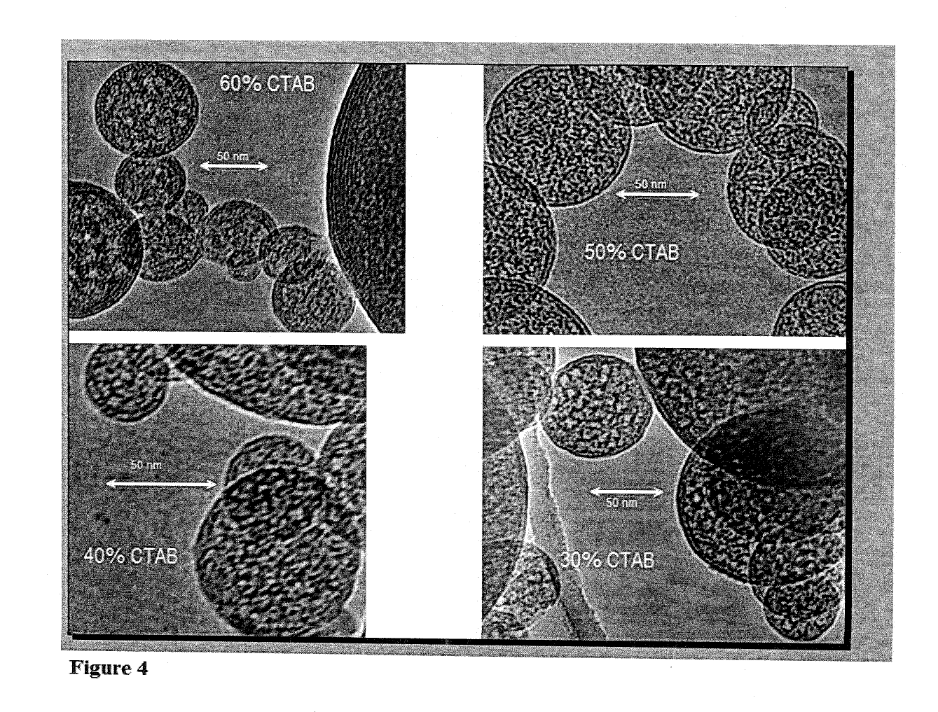

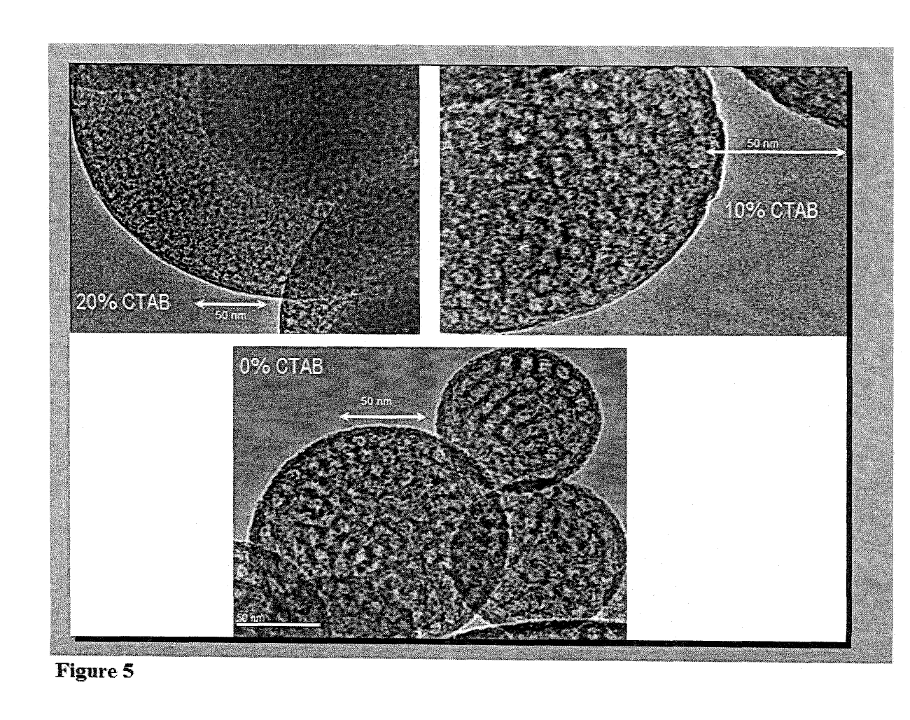

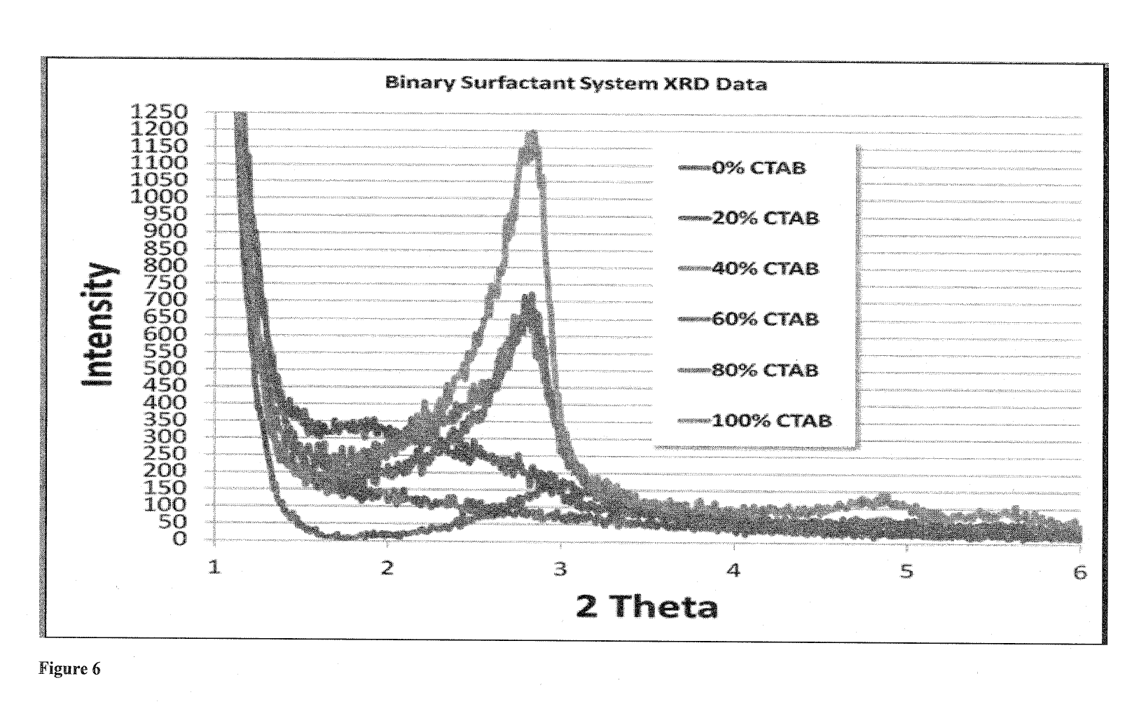

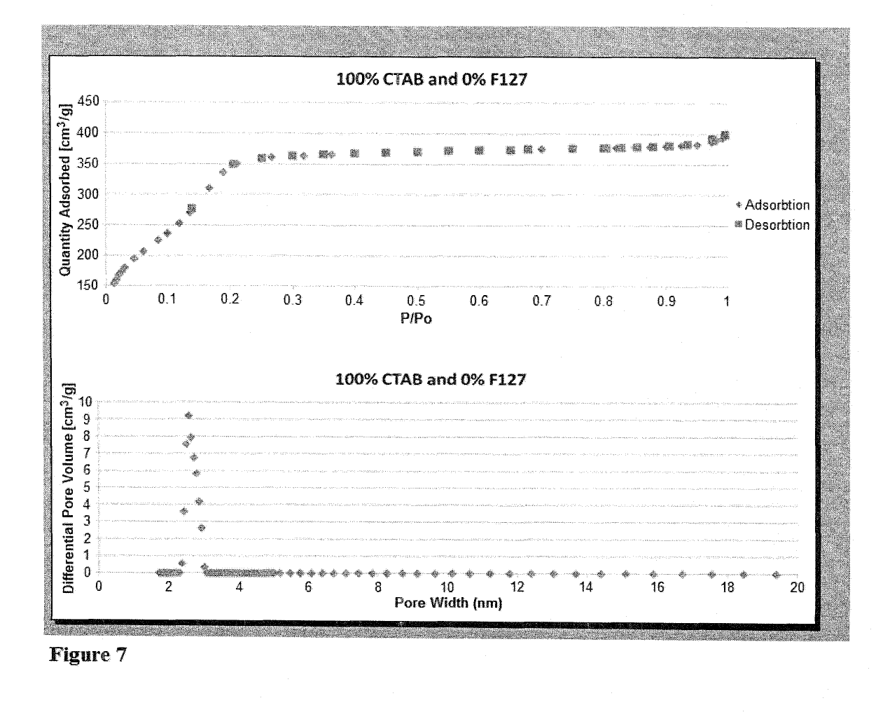

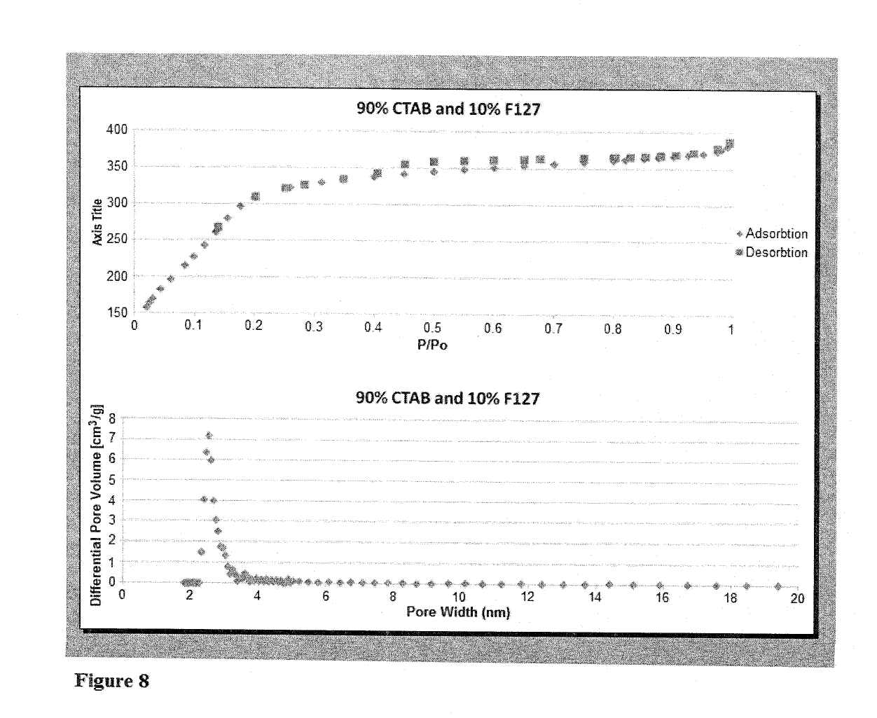

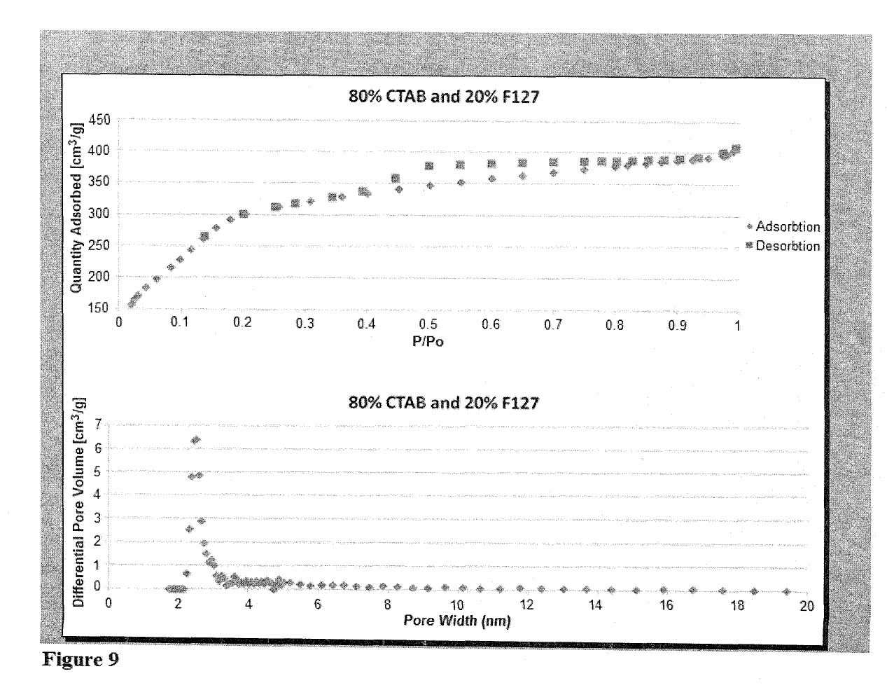

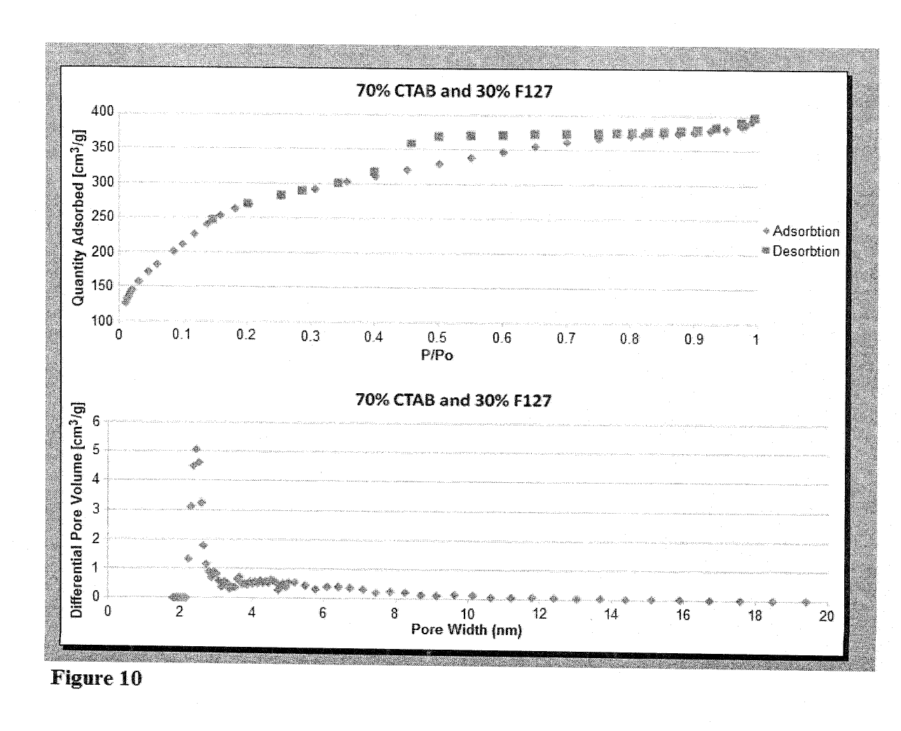

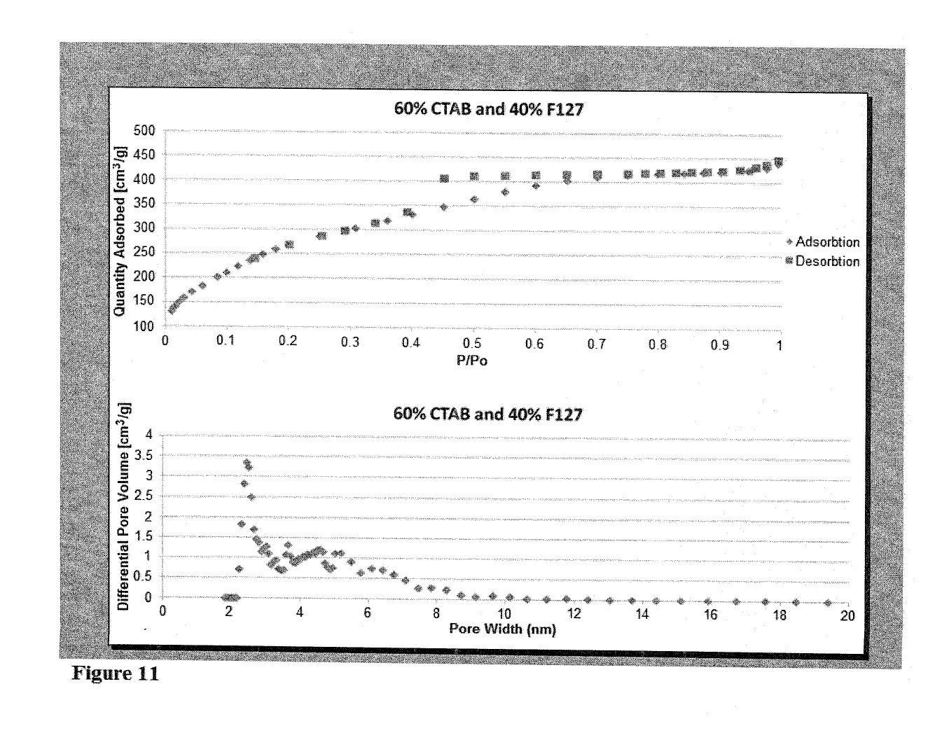

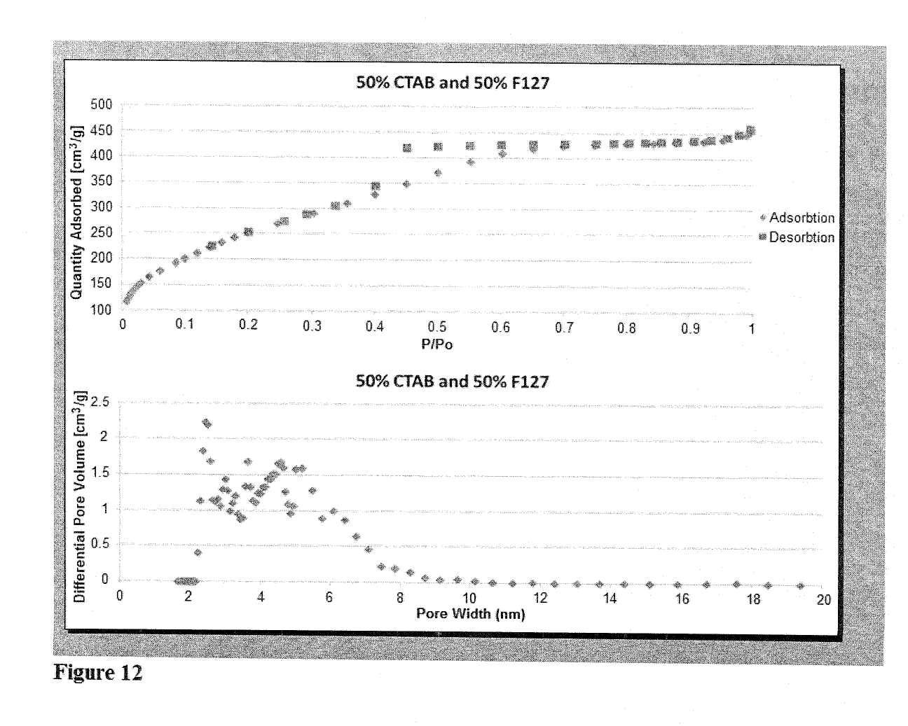

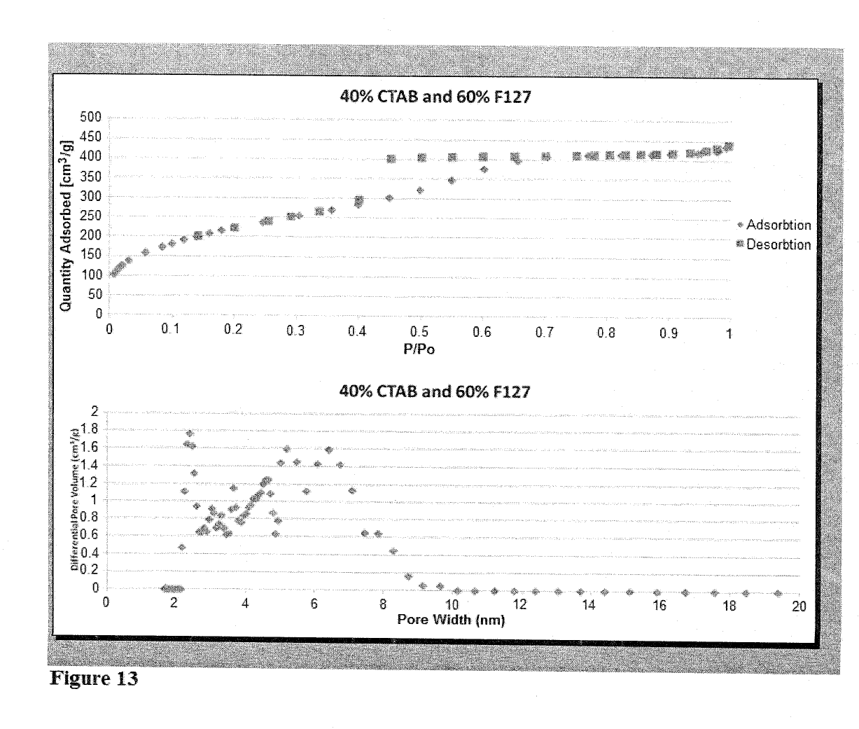

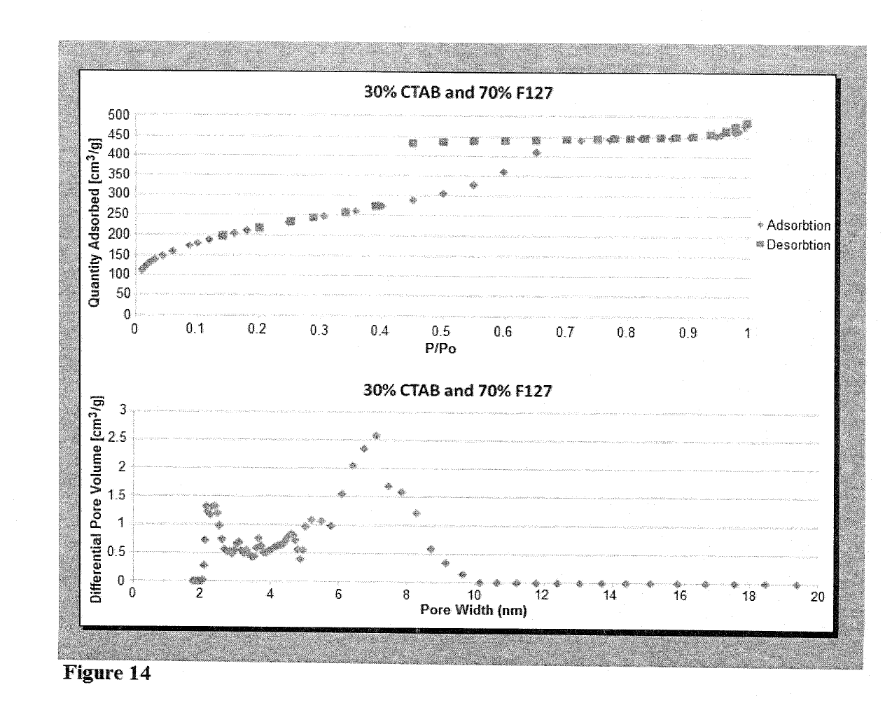

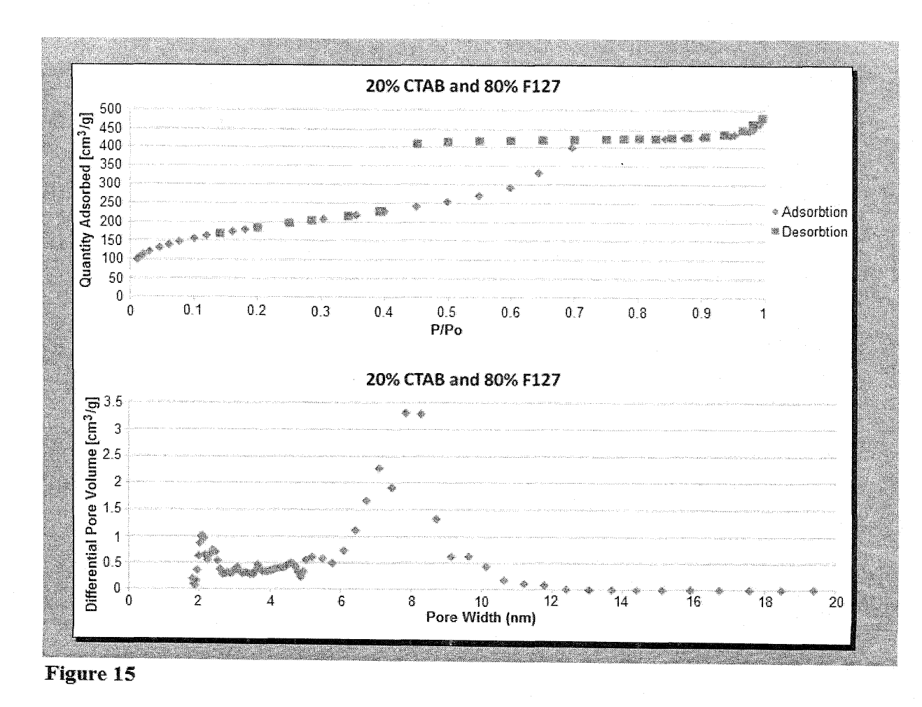

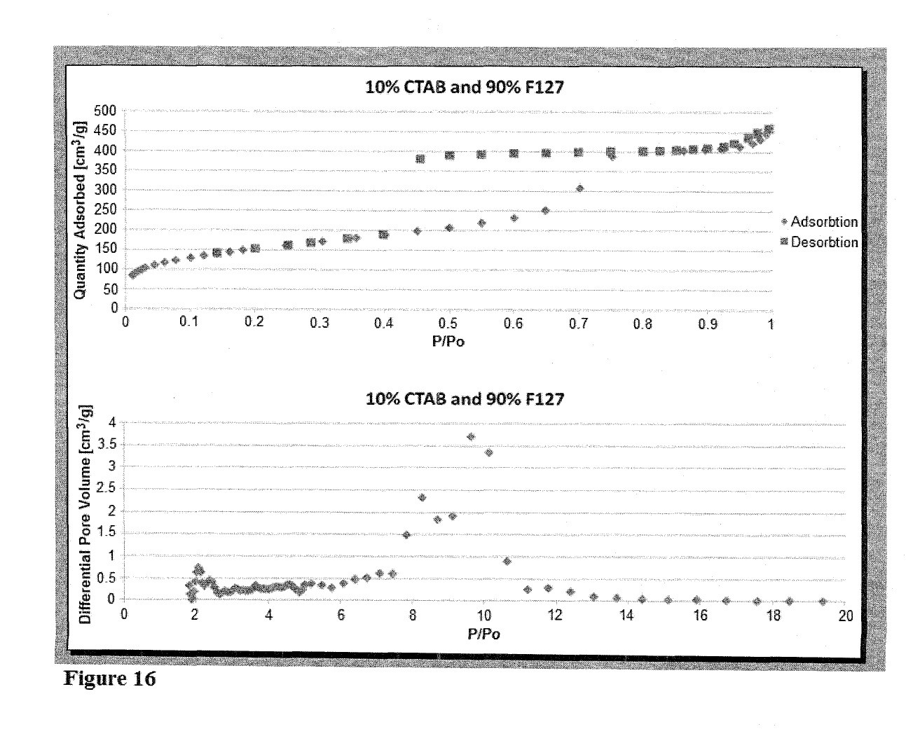

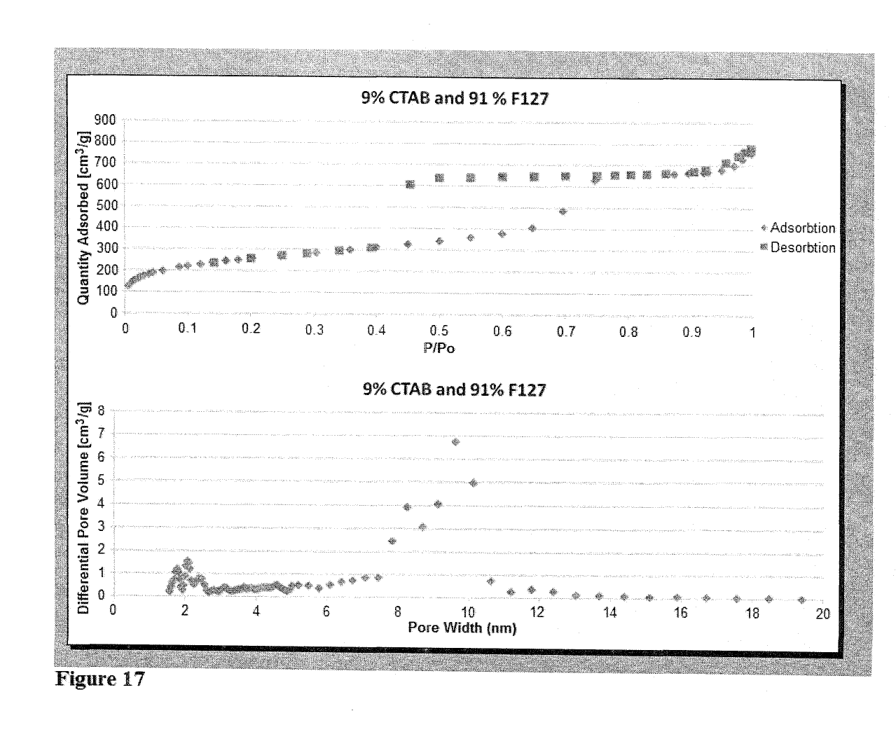

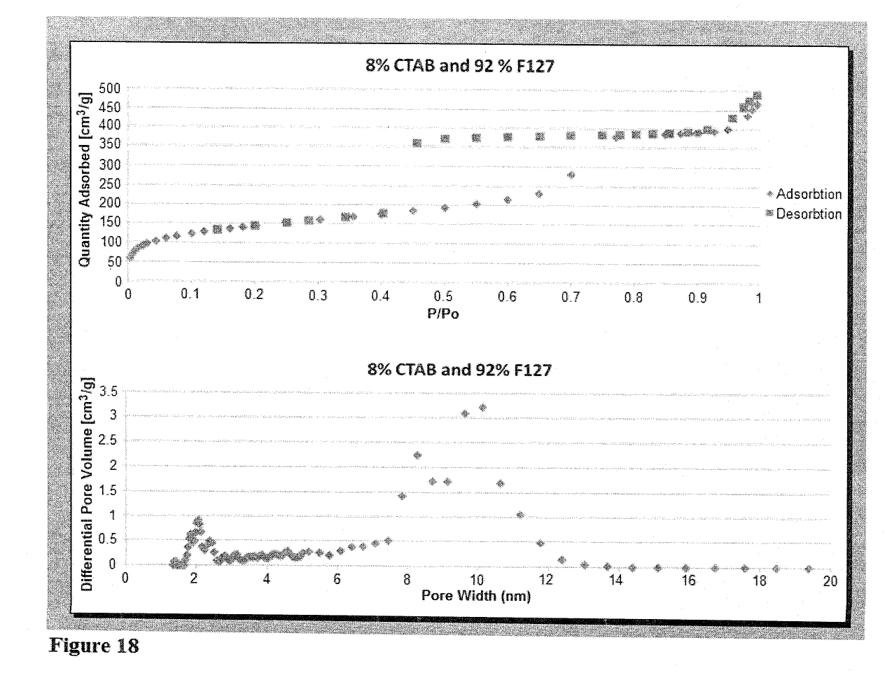

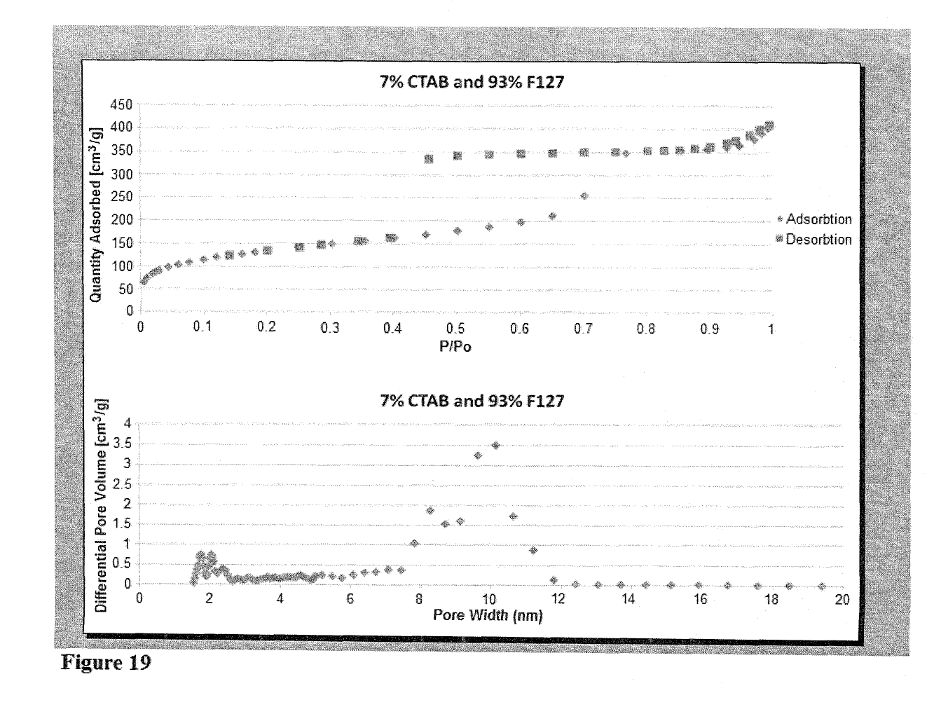

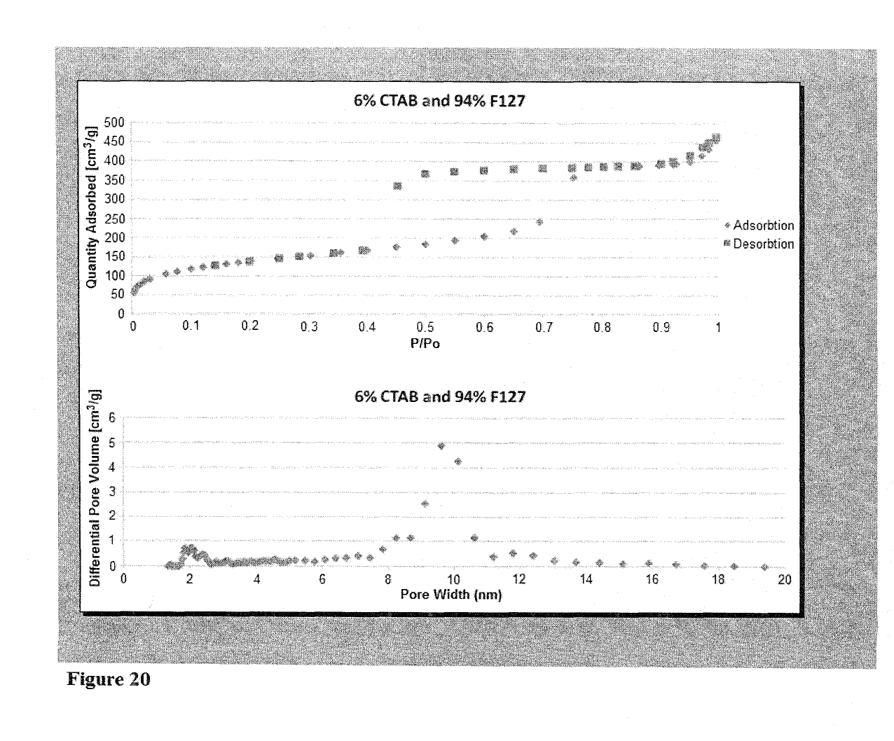

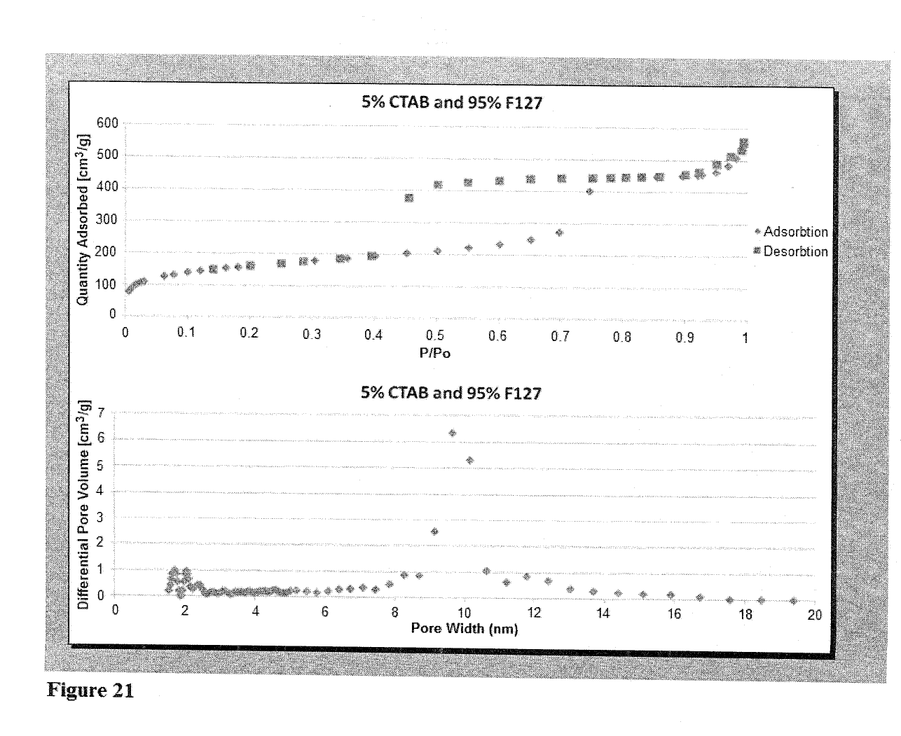

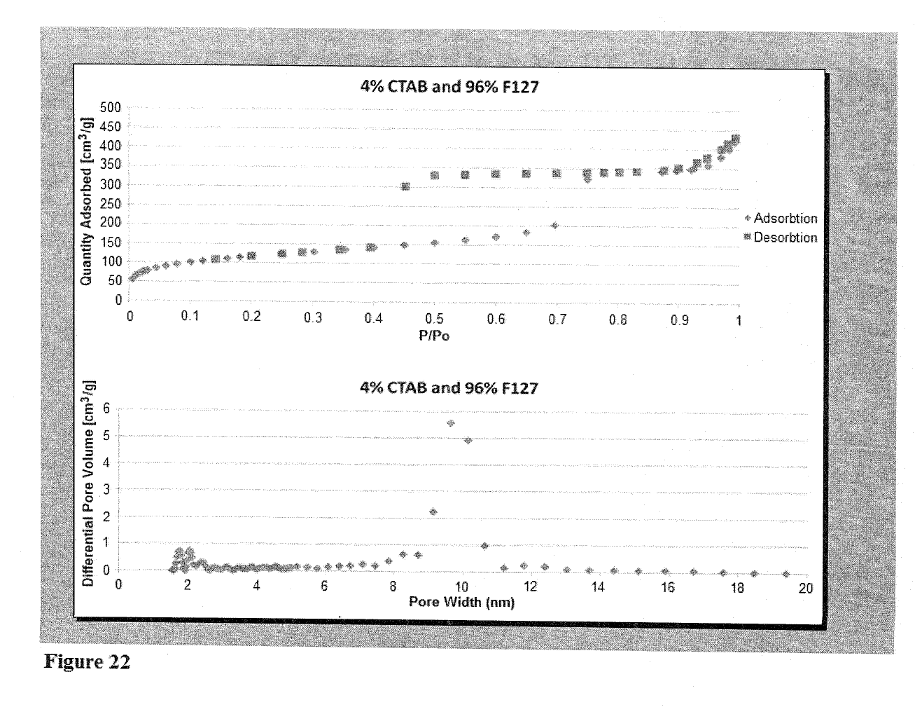

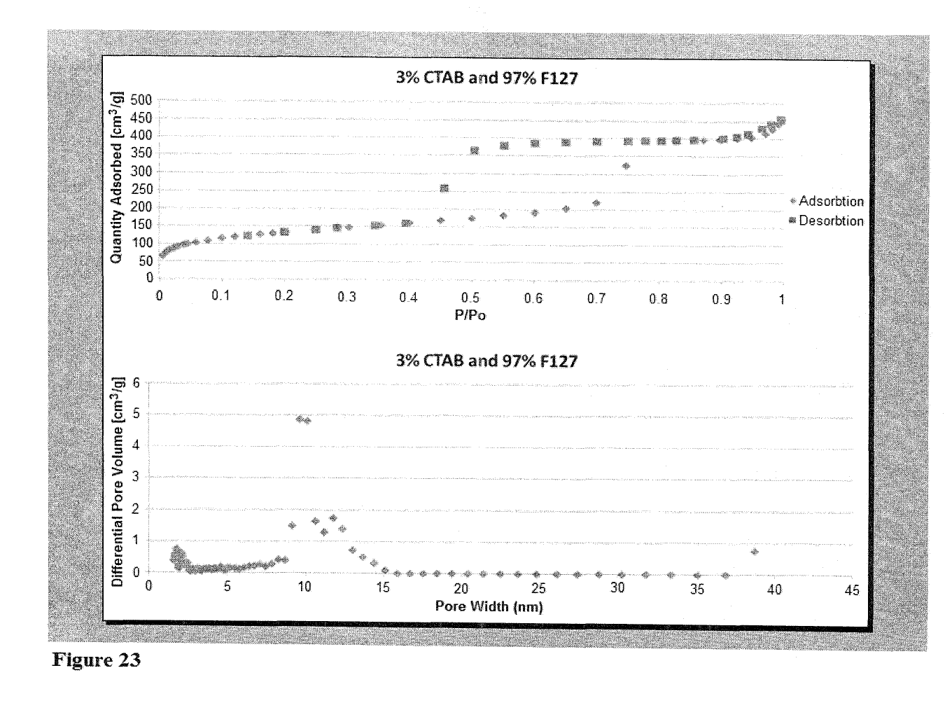

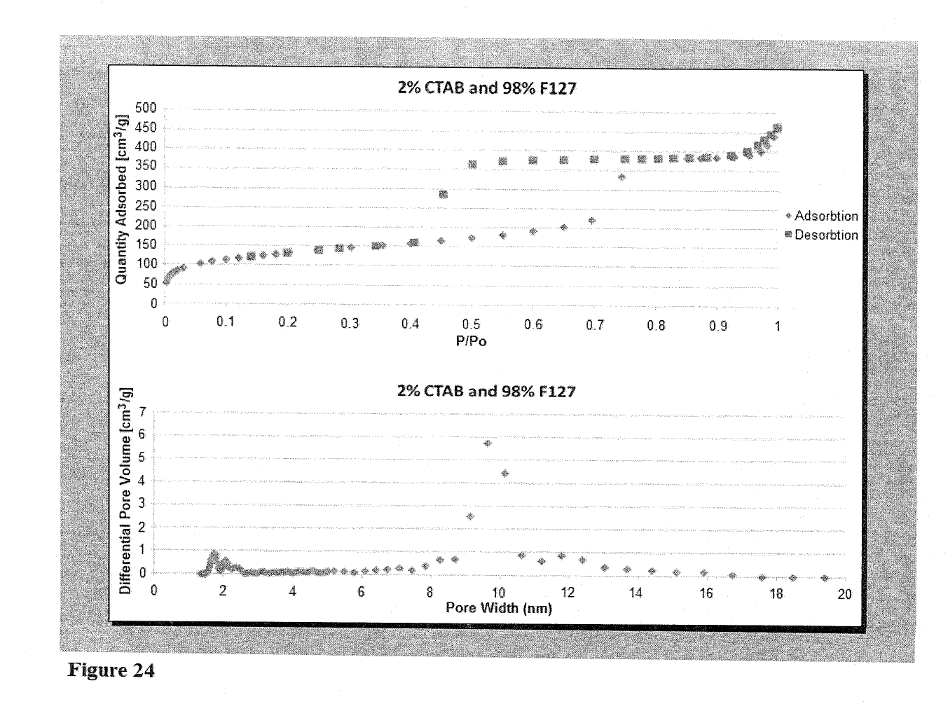

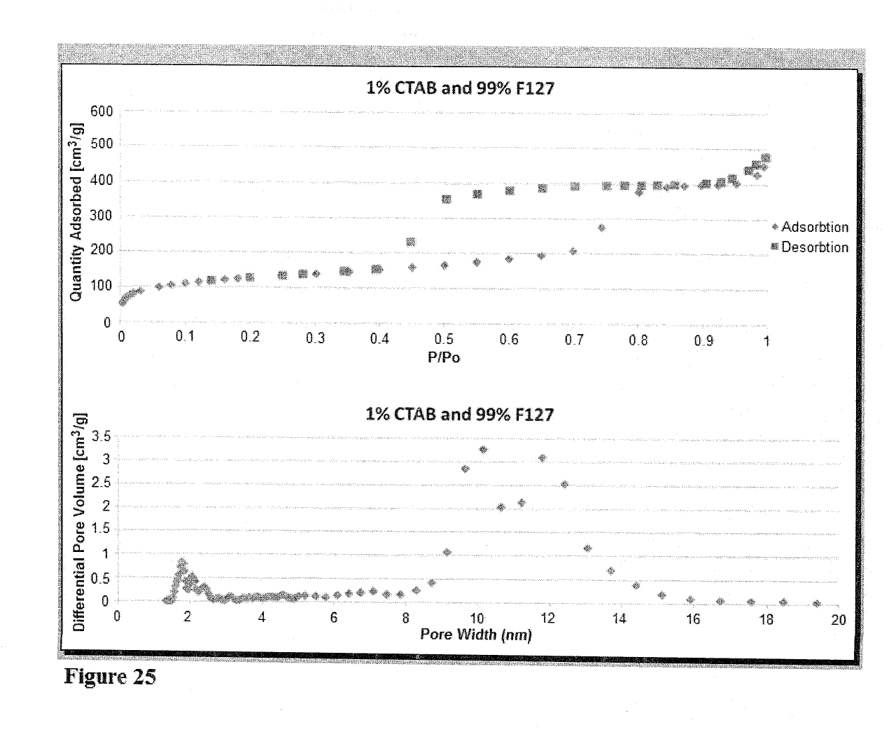

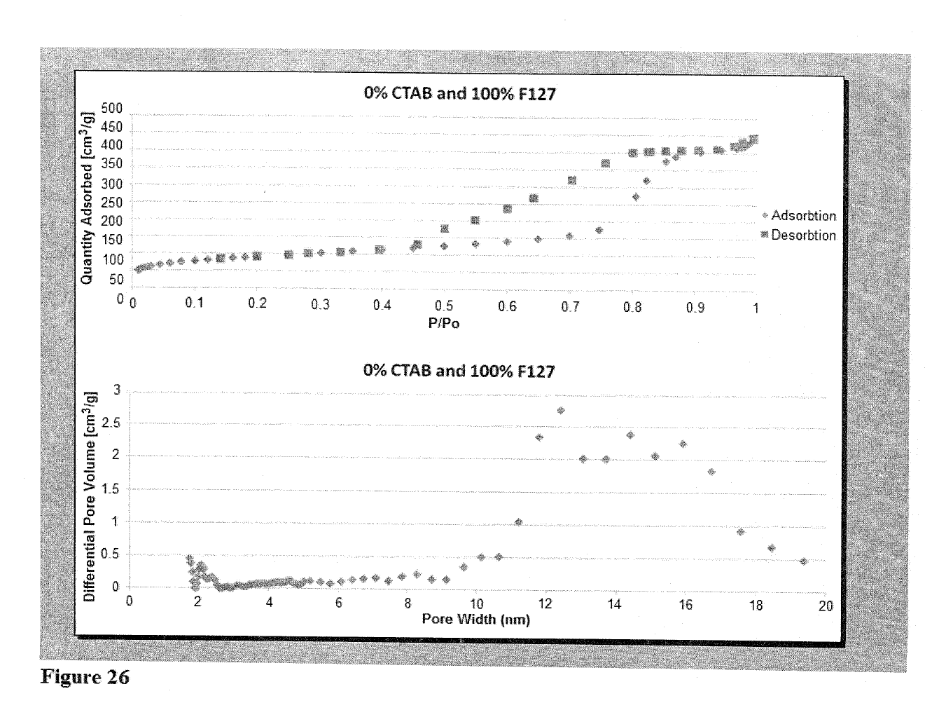

As seen in the XRD data of FIGS. 1-5, porosity was found to be a function of varying surfactant concentration in the EISA binary surfactant system. FIG. 6 also illustrates this phenomenon and shows binary surfactant system XRD data at different weight percentage ratios of cationic surfactant:poloxamer. As seen in FIGS. 7-26, varying the weight percentage ratio of cationic surfactant:poloxamer as described in this example affected both (a) adsorption and desorption and (b) pore size and differential pore volume.

### Example 2

### Synthesis of Multimodal Silica Nanoparticles Using an Emulsion Process

An emulsion process can be used to synthesize MSNPs with multimodal porosity as follows. About 1-3 g of P123 or F127 and hexadecyltrimethylammonium bromide (C₁₆; CTAB) are added to 20-30 g of deionized water, stirred at 30°-50° C. until dissolved, and allowed to cool to 25° C. Approximately 0.25-1.0 g of 1.0 N HCl, 3-7 g of TEOS, and 0.1-0.5 g of NaCl are added to the P123 or F127/CTAB solution, and the resulting sol is stirred for 0.5-3.0 hours. An oil phase composed of hexadecane with 3 wt % Abil EM 90 (a non-ionic emulsifier soluble in the oil phase) is prepared. The precursor sol is combined with the oil phase (1:3 volumetric ratio of sol:oil) in a 1,000-mL round-bottom flask, stirred vigorously for 1-3 minutes to promote formation of a water-in-oil emulsion, affixed to a rotary evaporator (R-205; Buchi Laboratory Equipment; Switzerland), and placed in an 80° C. water bath for 30 minutes. The mixture is then boiled under a reduced pressure of 100-150 mbar (25-35 rpm for 2-4 hours) to remove the solvent. Particles are centrifuged (Model Centra MP4R; International Equipment Company; Chattanooga, Tenn.) at 2,000-4,000 rpm for 20 minutes, and the supernatant is decanted. Finally, the particles are calcined at 400-600° C. for 4-6 hours to remove surfactants and other excess organic matter.

### Example 3

### Binary Surfactant Particle Generation Process, Generator, and Recipe

### Reagents:

59.9 mL H2O, 114.8 mL EtOH (200 proof), 4.0 g surfactant (i.e. 2.0 g of CTAB & 2.0 g F127 for 50/50 mixture), 1.1 mL 1M HCl solution, 11.17 mL Tetraethyl Orthosilicate.

### Generator:

Solution runs through TSI model 3076 Aerosol Generator (feed: nitrogen gas), which is connected to a 1′ length of ½″ O.D. flexible stainless steel tube, heated to 80° C. This 1′ length is then connected to a 4′ length of 1″ O.D. glass tube, heated in 3 areas (approximately 1.33′ long per area): 175° C. closest to the aerosol generator, followed by 250° C. immediately downstream, and 410° C. on the section of glass tube furthest downstream. The glass tube is then connected to another 1′ length of ½″ O.D. flexible stainless steel tube, this section is heated to 175° C. Finally, the previously mentioned section of ½″ O.D. flexible stainless steel tubing is connected to a 142 mm stainless steel filter housing, which is heated to 115° C. and contains the filter collection membrane. The generator exhaust downstream of the filter housing is passed through a HEPA filter and then vented to building exhaust.

### Process:

In a sealable container mix together sol reagents, allow for mixture to become homogeneous before adding Tetraethyl Orthosilicate (TEOS) to avoid polymerization of TEOS molecules. Transfer mixed sol to 1 L glass bottle included with TSI 3076 Aerosol Generator (see below). When sol has been mixed for approximately 10 minutes, connect 1 L bottle containing sol to the TSI 3076 Aerosol Generator. After all temperature zones on the generator have reached their set value, begin aerosolizing sol using nitrogen. The pressure of nitrogen gas flowing into the TSI 3076 Aerosol Generator is set to 30 PSIG. Aerosolizing the sol in this way creates droplets which are then evaporated as they flow down the length of the generator, resulting in silica nanoparticles. The particles are then captured on a 0.2 μm 142 mm polyethersulfone membrane. When the sol has been completely aerosolized and there is no remaining liquid, the filter is removed and particles are collected to have surfactant removed. Surfactant is removed from particles via calcination, where oven is at a temperature of 500° C. for eight hours. After calcination, particles are then recollected for use.

### REFERENCES FOR BACKGROUND OF THE INVENTION

(1) Nel, A. E.; Madler, L.; Velegol, D.; Xia, T.; Hoek, E. M. V.; Somasundaran, P.; Klaessig, F.; Castranova, V.; Thompson, M. Nat. Mater 2009, 8, 543.
(2) Albanese, A.; Tang, P. S.; Chan. W. C. W. Annu. Rev. Biomed. Eng. 2012, 14, 1.
(3) Dobrovolskaia, M. A.; Aggarwal, P.; Hall, J. B.; McNeil, S. E. Mol. Pharmaceut. 2008, 5, 487.
(4) Wang, J.; Byrne, J. D.; Napier, M. E.; DeSimone, J. M. Small, 2011, 14, 1919.

1. A mesoporous silica nanoparticle (MSNP) having a multiphase pore-surface structure and a multi-modal pore size distribution.

2. The mesoporous silica nanoparticle (MSNP) of claim 1, wherein the MSNP has at least two distinct pore sizes ranging from about (1) (i) 0.001 to about 2 nm, or from about 0.01 to about 2 nm, or from about 0.03 nm to about 2 nm and/or (ii) from greater than about 50 nm to about 100 nm, and (2) from greater than about 2 nm to about 50 nm.

3. The mesoporous silica nanoparticle (MSNP) of claim 1, wherein the MSNP is self-assembled using a templating surfactant system comprised of at least one anionic or cationic surfactant and at least one poloxamer, wherein the surfactants are immiscible with each other.

4. The mesoporous silica nanoparticle (MSNP) according to claim 1, wherein the MSNP:
(a) has two distinct pore sizes ranging from about 0.01 nm to about 2 nm and from greater than about 2 nm to about 50 nm;
(b) a differential pore volume of between about 1 cm³/g to about 10 cm³/g; and
(c) is self-assembled using a templating surfactant system comprised of at least one charged (anionic or cationic) surfactant and at least one poloxamer.

5. The mesoporous silica nanoparticle (MSNP) of claim 3, wherein the charged surfactant and the poloxamer have different phases and the MSNP has a biphasic pore-surface structure.

6. The mesoporous silica nanoparticle (MSNP) according to claim 3, wherein the templating surfactant system is comprised of three or more surfactant components, including at least one cationic surfactant and at least one poloxamer, and wherein at least three of said surfactant components have different phases.

7. The mesoporous silica nanoparticle (MSNP) according to claim 3, wherein the surfactant is selected from the group consisting of a dodecylsulfate salt (most preferably sodium dodecylsulfate or lithium dodecylsulfate (SDS)), a tetradecyl-trimethyl-ammonium salt (most preferably tetradecyl-trimethyl-ammonium bromide (C₁₄TAB) or tetradecyl-trimethyl-ammonium chloride), a hexadecyltrimethylammonium salt (mostly preferably hexadecyltrimethylammonium bromide (C₁₆; CTAB)), an octadecyltrimethylammonium salt (most preferably octadecyltrimethylammonium bromide (C₁₈; OTAB)), a dodecylethyldimethylammonium salt (most preferably dodecylethyldimethylammonium bromide), a cetylpyridinium salt (most preferably cetylpyridinium chloride (CPC)), polyethoxylated tallow amine (POEA), hexadecyltrimethylammonium p-toluenesulfonate, a benzalkonium salt (most preferably benzalkonium chloride (BAC)), or a benzethonium salt (most preferably benzethonium chloride (BZT)) and mixtures thereof.

8. The mesoporous silica nanoparticle (MSNP) according to claim 3, wherein the poloxamer has a polyoxyethylene content of between about 10% to about 80%.

9. The mesoporous silica nanoparticle (MSNP) according to claim 3, wherein the poloxamer is P123 or F127.

10. The mesoporous silica nanoparticle (MSNP) according to claim 3, wherein the cationic surfactant is hexadecyltrimethylammonium bromide (C16; CTAB).

11. The mesoporous silica nanoparticle (MSNP) according to claim 3, wherein the weight percentage ratio of charged surfactant:poloxamer varies from about 1:99, or from about 2:98, or from about 3:97, or from about 4:96, or from about 5:95, or from about 6:94, or from about 7:93, or from about 8:92, or from about 9:91, or from about 10:90, or from about 15:85, or from about 20:80, or from about 25:75, or from about 30:70, or from about 35:65, or from about 40:60, or from about 45:55, or from about 50:50, or from about 55:45, or from about 60:40, or from about 65:35, or from about 70:30, or from about 75:25, or from about 80:20, or from about 85:15, or from about 90:10 or from about 95:5, or from about 96:4, or from about 97:3, or from about 98:2, or from about 99:1.

12. The MSNP according to claim 1, wherein the MSNP is further coated with a lipid bilayer.

13. The MSNP according to claim 1, wherein the MSNP is further modified with SiOH.

14. The MSNP according to claim 1, wherein the MSNP is further modified with PEG.

15. The MSNP according to claim 1, wherein the MSNP is aminated.

16. The MSNP according to claim 1, wherein the MSNP is loaded with cargo.

17-33. (canceled)

34. A method of preparing a mesoporous silica nanoparticle (MSNP) that has a pore size of between about 0.03 nm to about 50 nm and a differential pore volume of between about 1 cm³/g to about 10 cm³/g, the method comprising forming a precursor mixture comprising a silica precursor and a templating surfactant system comprised of at least one cationic surfactant and at least one poloxamer which are immiscible; drying the precursor mixture to form a surfactant-based self-assembled template and a silica precursor-based mesostructure phase that is ordered by the template; and thermally treating the precursor to form the MSNP.

35. The method of claim 34, wherein the cationic surfactant and the poloxamer have different phases and the MSNP has a biphasic pore-surface structure.

36. The method of claim 34, wherein the templating surfactant system is comprised of three or more surfactant components, including at least one cationic surfactant and at least one poloxamer, and wherein at least three surfactant components have different phases.

37-38. (canceled)

39. A method of making a bimodal/multimodal mesoporous material comprising:
1) providing an aqueous silica precursor (sol) comprising tetraethylorthosilicate (TEOS) and/or tetramethylorthosilicate (TMOS) by adding and mixing TEOS and/TMOS to a mixture of a volatile solvent that is miscible with water and water at an acidic pH;
2) adding a charged surfactant and a poloxamer surfactant directly to the sol at concentrations of each surfactant which are immiscible in each other after evaporation of the volatile solvent and sonicating the surfactants in the sol to dissolve the surfactants to provide a single phase;
3) evaporating the volatile solvents from the single phase mixture produced in step 2 to promote self-assembly and multi-phase particle formation; and
4) after evaporating all of said solvent, collecting the particles and extracting any residual surfactant therefrom;
or
1) preparing a precursor mixture comprising at least one charged surfactant and at least one poloxamer surfactant and a silicon precursor in water, wherein said surfactant(s) and said poloxamer are immiscible in each other;
2) preparing an oil phase comprising at least one C₁₂-C₃₆ alkane, preferably at least one C₁₂-C₂₀alkane and an emulsifier;
3) combining the precursor mixture from step 1 with the oil phase from step 2 and vigorously stirring the precursor mixture with the oil phase to produce an emulsion;
4) evaporating solvent in the emulsion prepared from step 3 to produce nanoparticles therefrom;
5) separating the particles from remaining solvent; and
6) heating the separated particles to remove surfactants and any excess organic matter to provide bimodal or multimodal nanoparticles;
or
1) preparing a homogeneous surfactant solution from water, a volatile solvent miscible with water, at least one charged surfactant and at least one poloxamer surfactant wherein the charged surfactant and the poloxamer surfactant are immiscible in each other and an acid solution;
2) adding at least one silicon precursor to said surfactant solution and mixing to form a silicon precursor/surfactant mixture or sol;
3) aerosolizing the sol from step 3 under elevated temperature to produce droplets of the sol which are evaporated to produce nanoparticles which are captured on a capture membrane; and
4) collecting said particles and exposing said particles at elevated temperature to remove surfactant from said particles, wherein said particles are bimodal and/or multimodal.

40-53. (canceled)
